(19) United States
(12) Patent Application Publication
(10) Pub. No.: US 2013/0111127 A1
(43) Pub. Date: May 2, 2013

(54) STORAGE SYSTEM AND DATA PROCESSING METHOD IN STORAGE SYSTEM

(71) Applicants: Akihiko Araki, Sagamihara (JP); Akira Deguchi, Yokohama (JP)

(72) Inventors: Akihiko Araki, Sagamihara (JP); Akira Deguchi, Yokohama (JP)

(73) Assignee: Hitachi, Ltd.

(21) Appl. No.: 13/319,634

(22) PCT Filed: Oct. 28, 2011
(86) PCT No.: PCT/JP2011/006028

§ 371 Date: Nov. 9, 2011

(51) Int. Cl. G06F 12/00; G06F 12/16

(52) U.S. Cl. 711/114; 711/147; 711/E12.001; 711/E12.103

(57) ABSTRACT

When a snapshot virtual volume is provided to the host as an OS image of a virtual machine in a system where a single V-VOL is used by a single VM and all the VMs are started concurrently, burdensome Copy-on-Write (CoW) accesses placing heavy I/O loads on the storage occur in concentrated manner, and the starting time is elongated. The present invention solves the problem by measuring the I/O pattern (number of IO per unit time for reading/writing) in page units during starting of the system prior to having the VMs started concurrently, and based on the measurement results, performs saving and copying of the target pages of the write access to a snapshot pool prior to starting the VM. This preliminary saving enables to reduce the CoW accesses having a high access load, and to enable reduction of the VM starting time and efficient use of the pool capacity.

### TECHNICAL FIELD

The present invention relates to a storage system that adopts an art of controlling the load distribution thereof by dividing the logical volume in logical units and migrating the load units depending on the amount of load thereof.

### BACKGROUND ART

Storage systems are equipped with a snapshot function and other functions for enhancing the convenience of the system. By using the snapshot function, it becomes possible to create a snapshot which is a still image of the data in the storage system in operation taken at some point of time, and to maintain the same. Therefore, if the data of the storage system in operation is destroyed, the data at the point of time of creation of the snapshot can be restored.

Further, the snapshot volume created via the snapshot function is a logical copy of the original volume, so the snapshot volume consumes only the capacity corresponding to differential data from the original volume. Therefore, the snapshot function realizes an efficient backup of the storage system.

Recently, along with the advancement of server virtualization technique and desktop virtualization technique, a new use of the snapshot function for providing a snapshot volume created via the storage system to the host computer or virtual machines (VM) is considered. For example, if the data of the OS (Operating System) is stored in the original volume of the storage system, and a snapshot volume of the OS is created, it becomes possible to create a logical copy of the OS. By providing to the host a snapshot volume including the copied OS, it becomes possible to provide a large amount of servers and desktops to the host while consuming only a small amount of capacity. On the other hand, an art for acquiring a writable snapshot in the file system is known (patent literature 1). A snapshot is a still image of data taken at a certain point of time.

### CITATION LIST

### Patent Literature

PTL 1: U.S. Pat. No. 6,857,011

### SUMMARY OF INVENTION

### Technical Problem

The object of the present invention is to provide a storage system having a logical volume divided into logical units (such as 64-kilobyte logical page units), wherein the load information of respective logical pages is acquired and the data in the logical pages are migrated to other volumes based on the load information, so as to prevent the deterioration of performance.

Recently, a new method of use of the snapshot function which is a function for acquiring a logical backup consuming only a small amount of capacity have been proposed. Actually, the new method of use relates to logically copying original data such as operating systems (OS) or application programs (AP) via the snapshot function, and to provide the original data of the copied OS and AP to the virtual machines (VM).

The characteristic features of the above use enables to create, operate and manage a large amount of virtual machines at high speed. This attempt is effective since it consumes only a small amount of capacity, but if I/O load concentrates to the storage system such as when a large number of VMs are started simultaneously, the performance of the host is deteriorated. This problem is caused by the system of the snapshot function. In other words, the snapshot function is only capable of creating a logical backup, and the original data is not necessarily copied to another volume, wherein specific data are shared among a large amount of snapshot volumes. In other words, in order for the large number of VMs to share a specific data in the original volume, when a large amount of VMs issue I/Os simultaneously, the original volume receives concentrated load.

### Solution to Problem

In order to solve the above-mentioned problem, the present invention provides a storage system having a logical volume divided into predetermined units, wherein the load information of each predetermined unit of volumes is acquired and the predetermined units are migrated to other volumes based on the load information.

That is, if a snapshot virtual volume (V-VOL) is provided as OS image of the virtual machine (VM) to the host, a large number of V-VOLs are mapped to a single logical volume. Therefore, if a single VM utilizes a single V-VOL and the VMs are started all at once, burdensome CoW accesses casing a high I/O load concentrates in the storage system, and the starting time of the VMs are elongated. Therefore, the present system measures the I/O pattern (number of IOs per unit time during read/write accesses) during starting of the VMs for each logical page unit prior to having the VMs started all at once, and based on the measurement results, performs the saving and copying of the page to which the write access occurs to the snapshot pool prior to starting the VMs.

In further detail, the present invention provides a storage system coupled to a host computer, comprising a plurality of storage devices, and a controller for providing storage areas of the plurality of storage devices as logical volumes to the host computer, wherein a data shared among a plurality of virtual machines operating in the host computer is stored in one of said logical volumes, wherein the controller specifies an area within said one logical volume receiving a write request during starting of the virtual machines, creates one or more virtual volumes and sets a reference destination of the virtual volume to said one logical volume, copies the data stored in the specified area to another area of the storage device and changes the reference destination of the virtual volume referring to said area to the copy destination, maps the respective one or more virtual volumes to one of the plurality of virtual machines, and starts the plurality of virtual machines, wherein a data write request to a shared data having been copied is written into the copy destination that the virtual volume mapped to the virtual machine refers to.

### Advantageous Effects of Invention

The present invention enables to realize reduction of the number of CoW accesses causing a heavy access load to the system and load dispersion due to a preliminary saving process for performing the saving and copying of data in a storage area to which the load concentrates to a snapshot pool prior to starting the VM based on the load information, according to which the VM starting time is shortened and the pool capacity can be used effectively.

### BRIEF DESCRIPTION OF DRAWINGS

FIG. 1 shows a configuration example of a storage system according to embodiment 1 of the present invention.

FIG. 2 shows a configuration example of a snapshot according to embodiment 1 of the present invention.

FIG. 3 is a view showing an example of a corresponding relationship of the V-VOLs, the host computer and the VM according to embodiment 1 of the present invention.

FIG. 4 shows an example of a management information stored in the storage system according to embodiment 1 of the present invention.

FIG. 5 shows an example of a RAID group information according to embodiment 1 of the present invention.

FIG. 6 is a view showing one example of an LU information according to embodiment 1 of the present invention.

FIG. 7 is a view showing one example of a pair information according to embodiment 1 of the present invention.

FIG. 8 is a view showing one example of a P-VOL differential information according to embodiment 1 of the present invention.

FIG. 9 is a view showing one example of a V-VOL differential information according to embodiment 1 of the present invention.

FIG. 10 is a view showing one example of a pool free space information according to embodiment 1 of the present invention.

FIG. 11 is a view showing one example of a page queue according to embodiment 1 of the present invention.

FIG. 12 is a view showing an example of an RG selection table according to embodiment 1 of the present invention.

FIG. 13 is a view showing one example of a page performance information according to embodiment 1 of the present invention.

FIG. 14 is a view showing one example of a pool information according to embodiment 1 of the present invention.

FIG. 15 is a flowchart showing one example of a host write process to the P-VOL according to embodiment 1 of the present invention.

FIG. 16 is a flowchart showing one example of a save destination search process according to embodiment 1 of the present invention.

FIG. 17 is a flowchart showing one example of a differential saving process according to embodiment 1 of the present invention.

FIG. 18 is a flowchart showing one example of a host write process regarding the V-VOL according to embodiment 1 of the present invention.

FIG. 19 is a flowchart showing one example of a host read process regarding the V-VOL according to embodiment 1 of the present invention.

FIG. 20 is a flowchart showing one example of a VM starting process according to embodiment 1 of the present invention.

FIG. 21 is a flowchart showing one example of a preliminary saving process according to embodiment 1 of the present invention.

FIG. 22 is a flowchart showing one example of a copying process for preliminary saving according to embodiment 1 of the present invention.

FIG. 23 is a flowchart showing one example of a page deleting process according to embodiment 1 of the present invention.

FIG. 24 is a flowchart showing one example of a host write process regarding the V-VOL performed after preliminary saving according to embodiment 1 of the present invention.

FIG. 25 is a flowchart showing one example of a write process regarding the V-VOL performed after preliminary saving according to embodiment 1 of the present invention.

FIG. 26 is a flowchart showing one example of an inter-pool CoW (Copy-on-Write) process according to embodiment 1 of the present invention.

FIG. 27 is a view showing one example of a RAID group information according to embodiment 2 of the present invention.

FIG. 28 is a flowchart showing one example of a save destination search process according to embodiment 2 of the present invention.

FIG. 29 is a flowchart showing one example of an inter-pool CoW process according to embodiment 2 of the present invention.

FIG. 30 is a view showing a configuration example of a snapshot according to embodiment 3 of the present invention.

FIG. 31 is a view showing one example of a pair information according to embodiment 3 of the present invention.

FIG. 32 is a view showing one example of a VM setup screen according to embodiment 1 of the present invention.

### DESCRIPTION OF EMBODIMENTS

Now, one example of the preferred embodiments of the present invention will be described with reference to the drawings. In the present embodiments, the portions having the same structural units and denoted by the same reference numbers basically perform the same operations, so the detailed descriptions thereof are omitted.

In the following description, the information according to the present invention is described by using the term “information”, but the information can also be expressed by other expressions and data structures, such as “table”, “list”, “DB (database)” and “queue”. Upon describing the contents of the respective information, expressions such as “identification information”, “identifier”, “name” and “ID” can be used, wherein these expressions are replaceable.

In the following description, sometimes the term “program” is used as the subject for describing the invention. The “program” is executed by a processor to perform a determined process using a memory and a communication port (communication control unit), so that the term “processor” can also be used as the subject in the description. Further, the processes disclosed using a program as the subject can also be performed as a process executed via a computer or an information processing apparatus such as a management server. A portion or all of the program can be realized via a dedicated hardware, or can be formed into a module. Various programs can be installed to respective computers via a program distribution server or a storage media.

### Embodiment 1

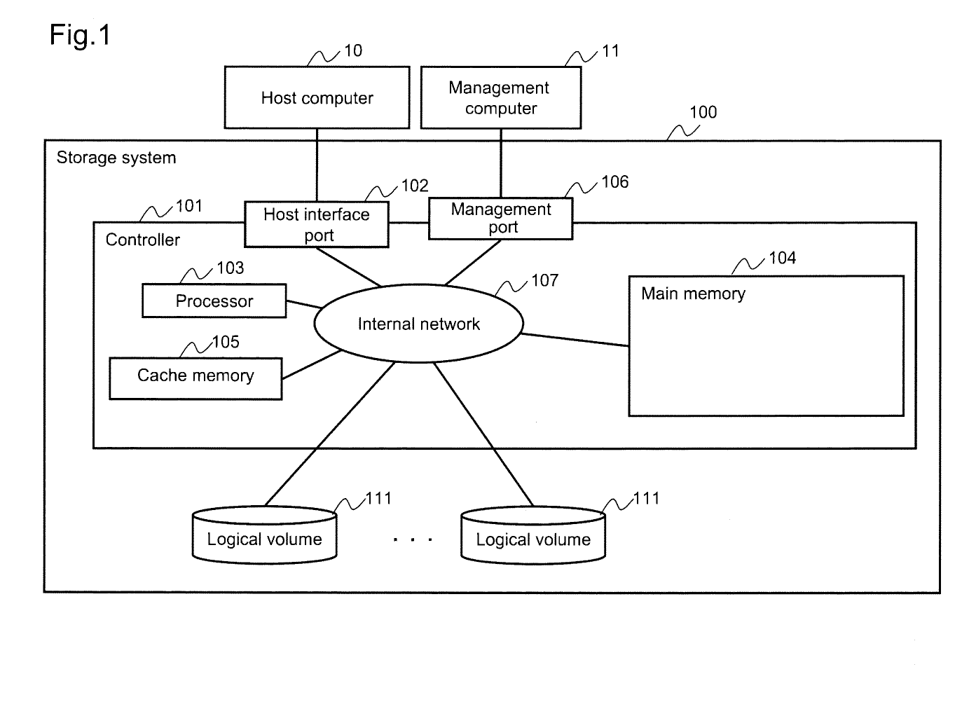

Now, the first embodiment of the present invention will be described with reference to FIGS. 1 through 26 and 32. FIG. 1 is a configuration illustrating one example of the storage system. The storage system 100 is composed of one or more controllers 101 for controlling the storage system 100, one or more host interface ports 102 for performing transmission and reception of data to and from the host computer 10, one or more processors 103, one or more cache memories 105, one or more main memories 104, one or more management ports 106 for connecting the storage system 100 and a management computer 11 for managing the storage system 100, a logical volume 111 for storing user data and the like, and an internal network 107 for mutually connecting the respective components such as the processor 103 and the cache memory 105.

Physically, the cache memory 105 can be the same memory as the main memory 104. The main memory 104 includes a control program and various management information. Although not shown, the control program is a software that interprets an I/O (Input/Output) request command issued by the host computer 10 to control the internal processing of the storage system 100 such as reading and writing of data. The control program includes functions for enhancing the convenience of the storage system 100 (including snapshots and dynamic provisioning). The management information will be described in detail later.

The host computer 10 recognizes the storage area assigned from the storage system 100 as a single storage device (volume). Typically, the volume is a single logical volume 111, but the volume can be composed of a plurality of logical volumes 111, or can be a thin provisioning volume as described in detail later. Although not shown, the logical volume 111 can be composed of a large number of storage media. Various kinds of storage media can exist in a mixture, such as HDDs (Hard Disk Drives) and SSDs (Solid State Drives). The storage system 100 can be equipped with a plurality of RAID groups in which storage media are formed into groups via RAID arrangement. By defining a plurality of logical volumes 111 via a single RAID group, the storage system 100 can use various logical volumes 111 with respect to the host computer 10.

Normally, logical volumes 111 are composed of a redundant structure formed by arranging HDDs and other nonvolatile storage media in a RAID (Redundant Array of Independent Disks) arrangement, but the present invention is not restricted to such arrangement, and other arrangements can be adopted as long as data can be stored thereto. The logical volumes 111 can store various management information other than user data that the storage system 100 stores. In the present invention, the logical volume is also simply called LU (logical Unit).

The main memory 104 stores various management information mentioned later. The storage system 100 also has a load monitoring function for managing the statuses of load of the host interface port 102, the processor 103, the cache memory 105 and the logical volume 111 included in its own system

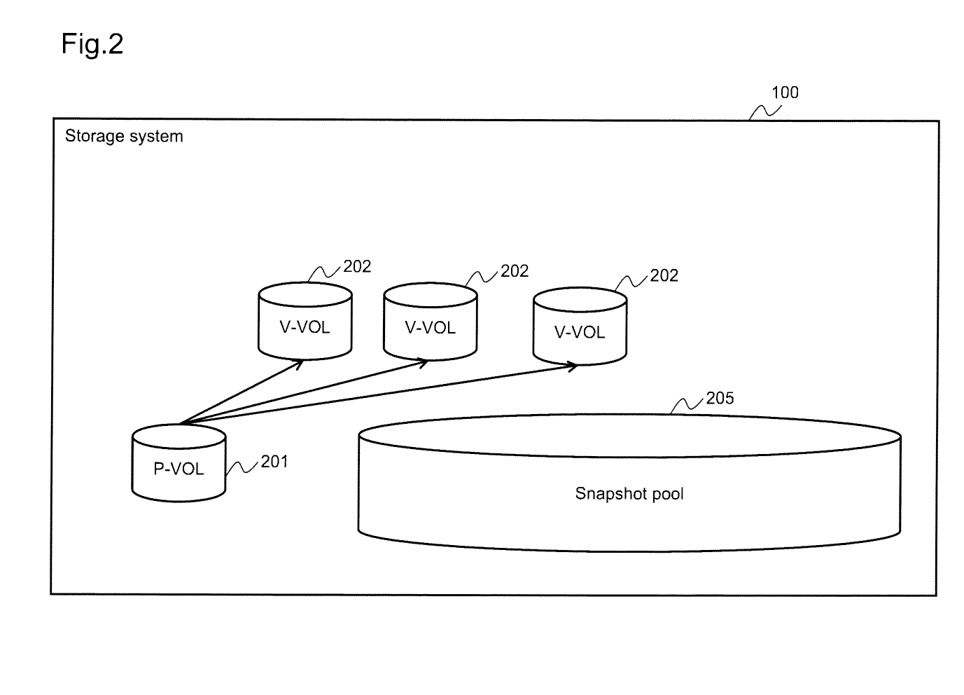

FIG. 2 is a configuration illustrating a snapshot arrangement of the storage system 100 according to the first embodiment. The storage system 100 is equipped with a P-VOL 201, a V-VOL 202 and a snapshot pool 205.

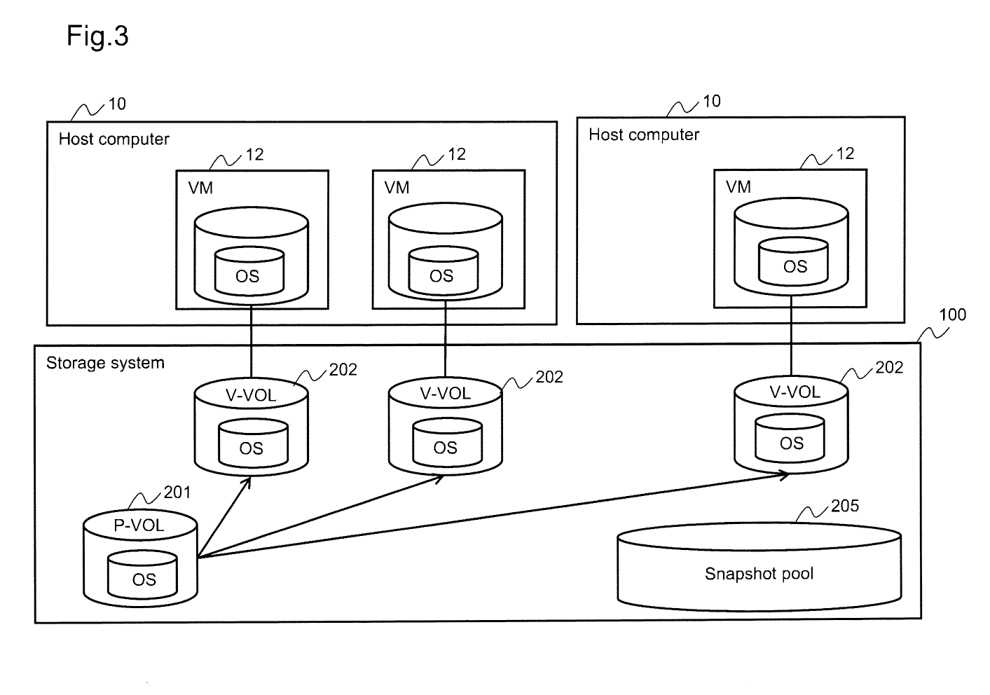

The P-VOL 201 is a source volume for acquiring a snapshot. The P-VOL stores the original data. Normally, the P-VOL is the logical volume 111. The V-VOL 202 is a snapshot volume created from the P-VOL 201. As shown in FIG. 3, multiple V-VOLs can be created from a single P-VOL.

The V-VOL 202 is a virtual volume that the storage system 100 has. The system of V-VOL 202 will now be briefly described. The V-VOL 202 only stores management information such as pointers, and the V-VOL 202 itself does not have a storage area. Pointers corresponding to each small area of the storage area of the P-VOL 201 divided into predetermined units, such as 64 KB units, are provided, and each pointer points to a storage area of either the P-VOL 201 or the snapshot pool 205. In the state immediately after creating the V-VOL 202, the user data is stored in the P-VOL 201 and all the pointers of the V-VOL 202 point to the P-VOL 201. In other words, the V-VOL 202 shares the user data with the P-VOL 201. As for the storage area of the P-VOL 201 to which update request has been issued from the host computer 10 or the like, the data in the small areas including the range of the storage area to which the update request has been issued is saved in the snapshot pool 205, and the pointers of the V-VOL 202 corresponding to the range of the storage area to which the update request has been issued point to the area in which data is saved in the snapshot pool 205. This operation enables the V-VOL 202 to logically retain the data of the P-VOL 201. In the present invention, the P-VOL 201 and the V-VOL 202 can be mounted in a host, and the host can perform reading or writing regardless of whether the mounted volume is the P-VOL 201 or the V-VOL 202, but it is also possible to restrict the reading/writing operations according to usage. The host can recognize the V-VOL 202 as a logical volume 111.

The snapshot pool 205 is a pool area storing the differential data generated between the P-VOL 201 and the V-VOL 202. The snapshot pool 205 can be a single logical volume 111 or can be formed of a plurality of logical volumes 111 being integrated. The P-VOL 201 or the snapshot pool 205 can be a so-called thin provisioning volume, wherein virtual capacities are provided to the host, and when an actual write request occurs, real storage capacities are dynamically allocated to the destination area of the write request.

FIG. 3 is a configuration showing the corresponding relationship of the V-VOL 202 and the host computer 10 according to the first embodiment. The host computer 10 has a plurality of virtual machines VM 12 formed in the interior thereof. The P-VOL 201 stores original OS data. The V-VOLs 202 created from the P-VOL 201 store a common OS data. However, at the time of creation of the V-VOLs 202, the V-VOLs 202 only store pointer information pointing to the P-VOL 201 and share the OS data with the P-VOL 201. When an update request is issued from the virtual machines VM to the V-VOLs 202, the update data is stored in the snapshot pool 205 and the V-VOLs 202 change the pointer information of the area to which update has been performed to the snapshot pool 205.

Each V-VOL 202 is mapped to a single VM 12. The corresponding relationship between V-VOL 202 and VM 12 can be managed not only via the storage system 100 but also via the management computer 11 or the host computer 10. The VM 12 having the V-VOL 202 mapped thereto can recognize the OS data of the V-VOL 202 mapped thereto and is capable of starting the OS.

Upon starting the OS, a host write request is issued from the VM 12 to the OS data portion of the V-VOL 202, the details of the internal operation of the storage system 100 at that time will be described in detail later. Further in FIG. 3, only the OS data is illustrated as the data being stored in the P-VOL 201 and the V-VOLs 202, but the OS data can also have a specific application program installed thereto in addition to OS data. In that case, by adjusting the load monitoring period described later, not only the OS but also the application program can be started speedily.

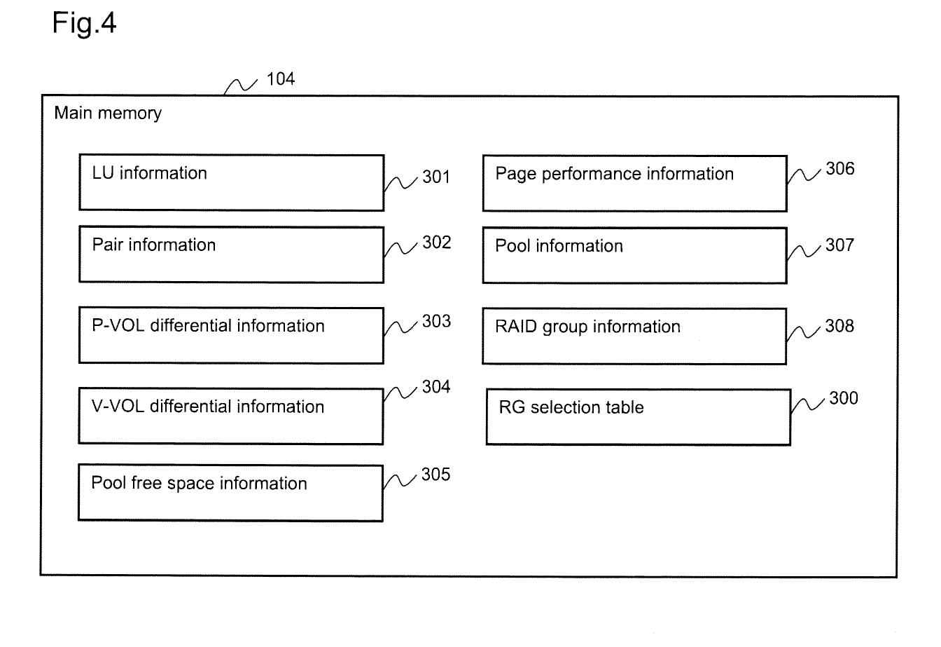

FIG. 4 is a configuration showing a list of management information according to the first embodiment. The main memory 104 comprises an LU information 301, a pair information 302, a P-VOL differential information 303, a V-VOL differential information 304, a pool free space information 305, a page performance information 306, a pool information 307, a RAID group information 308, and an RG selection table 300.

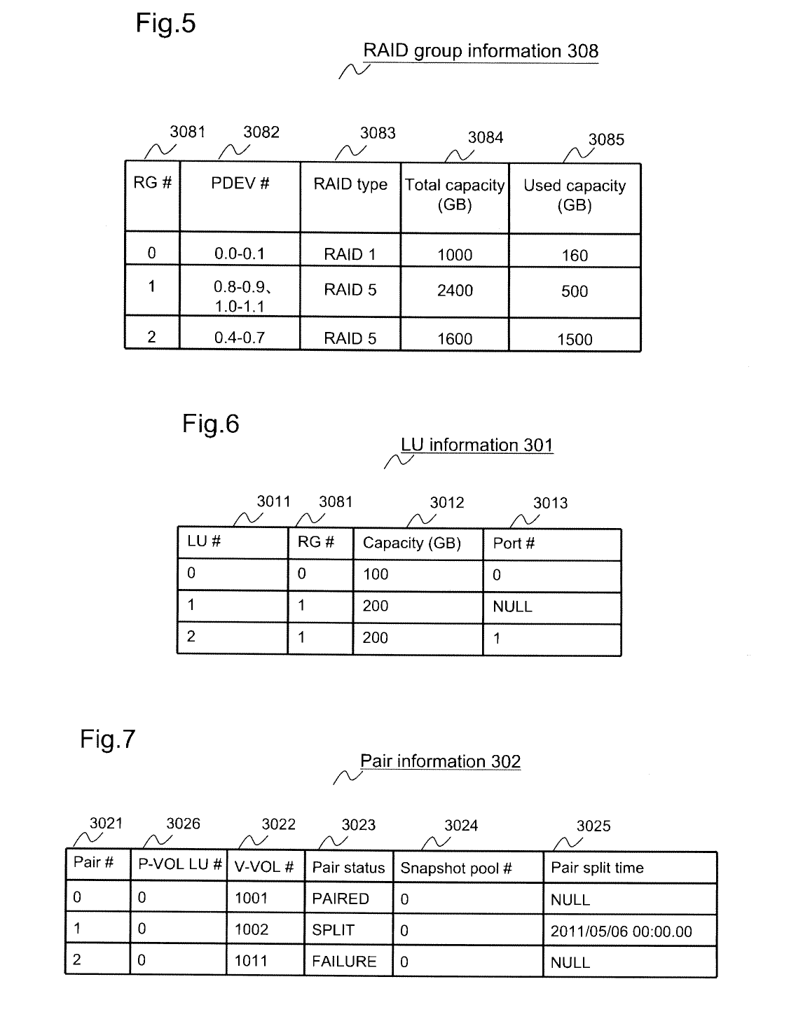

FIG. 5 is a RAID group information 308 according to embodiment 1. The RAID group information 308 is a table composed of an RG # (RAID Group number) 3081, a PDEV # (PDEV number) 3082, a RAID type 3083, a total capacity (GB) 3084, and a used capacity (GB) 3085. The RG #3081 is an identification number for uniquely identifying a plurality of RAID groups that the storage system 100 has.

The PDEV #3082 shows the identification number of the storage media constituting the RAID group. For example in FIG. 5, the entry in which the RG #3081 is “2” has “0.4-0.7” stored as the PDEV #3082, wherein the left side of the period shows the number of a casing storing the storage media and the right side of the period shows the position within the casing.

In other words, “0.4-0.7” means that four storage media from the fourth position to the seventh position in casing number 0 storing the storage media constitute the RAID group. If the storage media constituting the RAID group are arranged astride a plurality of casings, they can be shown using a comma, such as in the entry in which the RG #3081 is “1”.

The RAID type 3083 refers to the type of the RAID constituting the RAID group. FIG. 5 illustrates only RAID1 and RAID5 as examples, but other types of RAIDs can be used. The total capacity (GB) 3084 is the maximum capacity that the RAID group has, which is shown in GB units. The usage capacity (GB) 3085 shows the already used capacity within the RAID group in GB units.

FIG. 6 is a view showing an LU information 301 according to embodiment 1. The LU information 301 is a table composed of the following items: an LU # (Logical Unit number) 3011, an RG #3081, a capacity (GB) 3012, and a port # (port number) 3013. The LU #3011 shows the LU number, which is an identification number for uniquely identifying the plurality of logical volumes 111 included in the storage system 100.

The RG #3081 is an identification number showing the RAID group to which the LU belongs, which can be the same value as the RG #3081 of the RG information 308. One LU is at least defined via a single RG. The capacity (GB) 3012 shows the capacity that the LU has in GB units.

The port #3013 is an identification number showing the host interface port 102 to which the LU is mapped. If the LU is not mapped to the host interface port 102, “NULL” can be entered to the port #3013.

Although not shown, if the logical volume is a thin provisioning volume, mapping tables should be prepared to show whether allocation has been performed for each allocation unit for allocating to the logical volume. Further, a separate mapping table of RAID groups and allocation units should be prepared.

FIG. 7 shows a pair information 302 according to embodiment 1. The pair information 302 is a management information of the P-VOL 201 and the V-VOL 202. Actually, the pair information 302 is a table composed of a pair # (pair number) 3021, a P-VOL LU # (P-VOL LU number) 3026, a V-VOL # (V-VOL number) 3022, a pair status 3023, a snapshot pool # (snapshot pool number) 3024, and a pair split time 3025. The pair #3021 is a number for uniquely identifying the pair of P-VOL 201 and V-VOL 202 of the storage system 100. For example, if three V-VOLs 202 are created from a single P-VOL 201 as shown in FIG. 2, three pair # are required. In the present invention, the pair composed of P-VOL 201 and V-VOL 202 is simply called a pair.

The P-VOL LU #3026 shows the LU # of the P-VOL 201 belonging thereto. The P-VOL LU #3026 can be the same value as the LU #3011 of the LU information 301. The V-VOL #3022 is a number for identifying the V-VOL 202 belonging to the pair. The V-VOL 202 is not a logical volume 111 within the storage system 100. However, in order to enable the host computer to recognize the V-VOL, the storage system 100 must assign a volume number to the V-VOL 202. Therefore, the storage system 100 assigns a respective number for uniquely identifying the V-VOL as V-VOL #3022 to each V-VOL 202.

The pair status 3023 shows the status of the pair. According to the pair statuses, “PAIRED” indicates a state in which the contents of the P-VOL 201 and V-VOL 202 mutually correspond, “SPLIT” indicates a state in which the V-VOL 202 stores the status of P-VOL 201 at some point of time, and “FAILURE” indicates a state in which a pair cannot be created due to some failure or the like.

If the pair status 3023 is “SPLIT”, it means that there may be a differential data generated between the P-VOL 201 and the V-VOL 202. In order for the pair status 3023 to be transited from “PAIRED” to “SPLIT”, it is preferable for the administrator to send a command for transiting to “SPLIT” status via the management computer 10 to the storage system 100. However if the storage system 100 has a scheduling function, it is possible for the storage system 100 to set the state automatically to “SPLIT” at a certain time.

Further, in order to do so, the storage system 100 must create a V-VOL 202 in advance and to create a pair with the P-VOL 201. In FIG. 7, three pair statuses 3023, “PAIRED”, “SPLIT” and “FAILURE”, are shown as examples, but other pair statuses are also possible. For example, if a failure has occurred in the snapshot pool 205, information indicating the location of failure can be shown within brackets, such as “FAILURE (POOL)”.

Depending on the method of the snapshot function, it is possible to omit the pair status 3023. For example, if the method only considers whether a snapshot has been taken or not, there will be no pair status, and the V-VOL 202 is simply either created or not created. At this time, the created V-VOL 202 corresponds to the “SPLIT” status according to the present embodiment, and the V-VOL retains the status of P-VOL 201 at a point of time when the snapshot has been taken.

The snapshot pool #3024 is an identification number for uniquely identifying the snapshot pool 205 storing the differential data when differential data occurs in the pair, and a unique number must be assigned to each snapshot pool 205. The pair split time 3025 shows the time in which the pair status 3023 of the pair is transited from “PAIRED” to “SPLIT”. This information is necessary for managing the order in which the pairs were split. If the pair status 3023 is either “PAIRED” or “FAILURE”, the V-VOL 202 does not retain the status of P-VOL 201 at some point of time, so that the pair split time 3025 can store a value such as “NULL”.

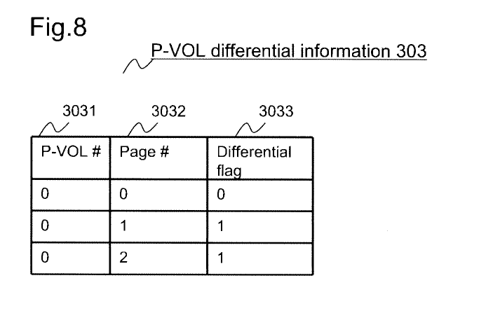

FIG. 8 shows a P-VOL differential information 303 according to embodiment 1. The P-VOL differential information 303 is a table composed of a P-VOL # (P-VOL number) 3031, a page #3032 (page number), and a differential flag 3033 for managing whether differential data exists with respect to the P-VOL 201. The P-VOL #3031 is an identification number for uniquely specifying the P-VOL 201 that the storage 100 has, and can be the same value as the LU #3011 of the LU information 301 (FIG. 6).

The page #3032 shows the serial number per storage area dividing the P-VOL 201 into predetermined units. Predetermined units refer to the capacity unit of differential data managed via the snapshot function, which can be sizes such as 64 KB or 256 KB. These predetermined units are called pages.

The differential flag 3033 indicates whether or not a difference has occurred between the relevant page of the P-VOL 201 with the V-VOL 202 constituting a pair therewith. If a difference has occurred, “1” is entered, and if there is no difference, “0” is entered thereto. If a plurality of V-VOLs 202 are created from a single P-VOL 201, if differences have occurred with respect to all the V-VOLs 202, the differential flag 3033 is set to “1”.

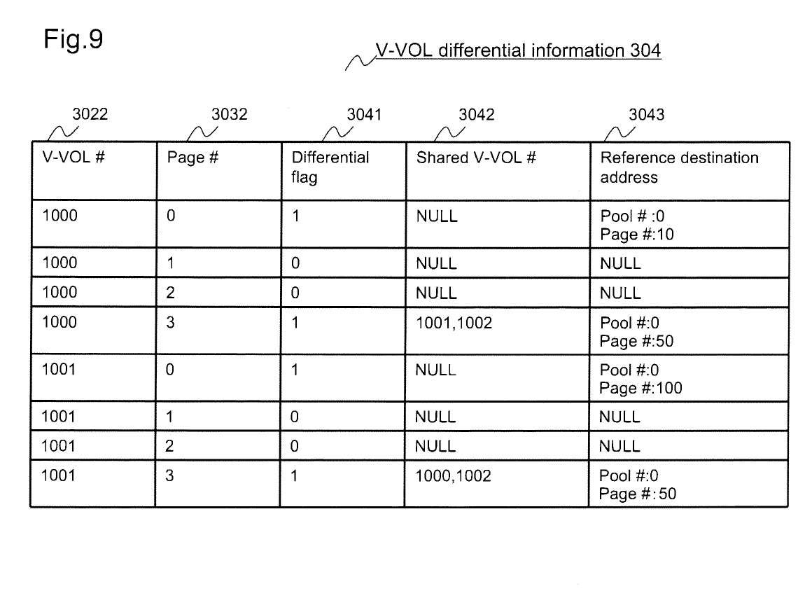

FIG. 9 shows a V-VOL differential information 304 according to embodiment 1. The V-VOL differential information 304 is a table composed of a V-VOL #3022, a page #3032, a differential flag 3041, a shared V-VOL #3042 (a shared V-VOL number) and a reference destination address 3043 for managing whether differential data exists with respect to the V-VOL 202.

The V-VOL #3022 is an identification number for uniquely specifying the V-VOL 202 equipped to the storage system 100, and can be the same value as the V-VOL #3022 of the pair information 302. The page #3032 of the V-VOL differential information 304 can be the same value as the page #3032 of the P-VOL differential information 303 (FIG. 8).

The differential flag 3041 has a different ON trigger of the flag compared to the differential flag 3033 of the P-VOL differential information 303. The differential flag 3033 of the P-VOL differential information 303 is turned ON (“1”) when a difference occurs with respect to all the V-VOLs 202 created from the P-VOL 201 upon saving the differential data in a host write operation to the P-VOL 201. On the other hand, the differential flag 3041 of the V-VOL differential information 304 is turned ON (“1”) when differential data is saved during a host write operation to the P-VOL and during a host-write operation to the V-VOL.

The shared V-VOL #3042 shows the V-VOL #3022 that shares the differential data of the relevant page of the relevant V-VOL 202 if that differential data is shared with other V-VOLs 202. Now, we will easily describe the sharing of differential data. We will consider a case in which two V-VOLs 202 are created from a single P-VOL 201 and two pairs are created, and then the two pairs are simultaneously set to “SPLIT” status.

At this time, if a host write request is issued to a certain page of the P-VOL 201, the two V-VOLs 202 retain a still image of the P-VOL 201 at the same point of time, so that the differential data occurs simultaneously for two V-VOLs 202.

However, it is a waste to retain a plurality of the same differential data in an overlapped manner. Therefore, if a plurality of V-VOLs 202 retain a still image of the same page at the same point of time, the differential data at the time of host write to the P-VOL 201 is shared among the plurality of V-VOLs 202. Thereby, the waste of differential data is solved, and the capacity can be saved. Therefore, the sharing of differential data becomes necessary. Sharing is realized by storing the information of V-VOL #3022 sharing the data to the shared V-VOL #3042.

Further, if the differential data is to be shared among a plurality of V-VOLs 202, the respective V-VOL #3022 should be entered. If there are a large number of V-VOLs 202 sharing the differential data, in order to cut down the amount of information of the management information, it may be possible to use a bitmap in which a single V-VOL 202 is represented via a single bit. If there are no other V-VOLs 202 sharing the differential data, “NULL” is entered thereto.

The reference destination address 3043 indicates the storage destination address of the data that the page of the V-VOL 202 refers to. For example, if there is no difference generated in a page and the page is identical to the page of the P-VOL 201, the processor 103 or the like of the storage system 100 can enter “NULL” in the reference destination address 3043 and the relevant page of the P-VOL 201 can be referred to.

On the other hand, if a difference has occurred to the page, the relevant page of the relevant V-VOL 202 must refer to the differential data, so that the processor 103 enters an address information uniquely identifying the destination for saving the differential data to the reference destination address 3043. The address information can be, for example, a combination of the identification number of the snapshot pool 205 and the serial number of the page disposed in the snapshot pool 205.

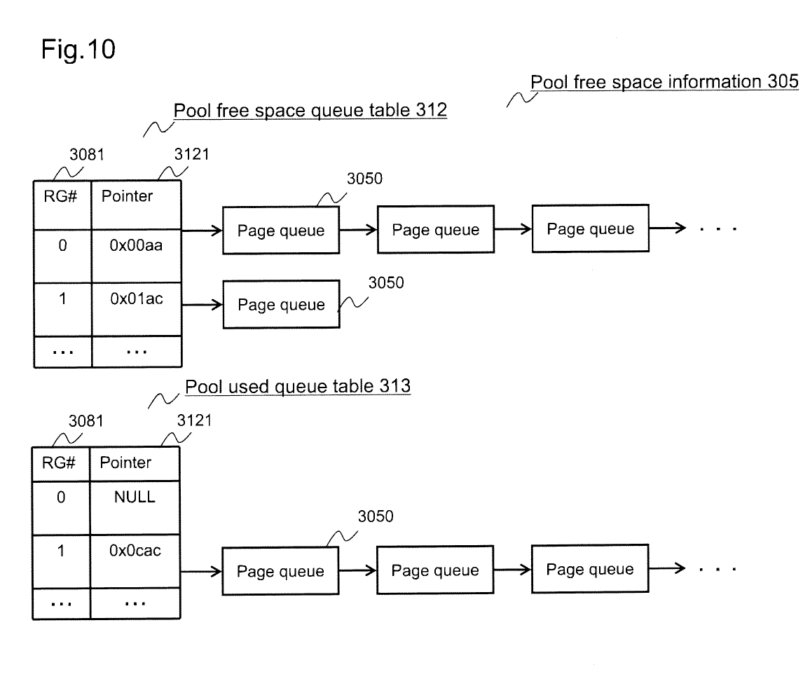

FIG. 10 is a view showing the pool free space information 305 according to embodiment 1. The pool free space information 305 is a table composed of a pool free queue table 312 and a pool used queue table 313 for managing the free space information in units of pages constituting the snapshot pool 205. The pool free queue table 312 and the pool used queue table 313 are each prepared for each snapshot pool 205.

The respective queue tables are tables composed of an RG #3081 and a pointer 3121, wherein the RG #3081 stores an identification number of the RAID group constituting the snapshot pool 205, which can be the same information as the RG #3081 of the RAID group information 308 (FIG. 5).

A pointer 3121 has a page queue 3050 belonging to the relevant RAID group connected thereto. A page queue 3050 refers to an information storing the differential data of the snapshot pool 205, and a plurality of queues are provided for each snapshot pool 205. The number of page queues 3050 are determined based on the capacity of the snapshot pool 205. For example, if differential data is stored in pages of 64 KB units to the snapshot pool 205 having a capacity of 10 GB, the number of page queues 3050 will be 10 GB/64 KB=163840. At this time, the pool free space information 305 has 163840 page queues 3050.

Further, the number of page queues 3050 are allocated for each capacity of the RAID groups constituting the snapshot pool 205. For example, it is assumed that the snapshot pool 205 having a capacity of 10 GB is composed of three RAID groups, and the capacity of each RAID group is 5 GB, 3 GB and 2 GB. In that case, the number of page queues 3050 belonging to the respective RAID groups is 81920, 49152 and 32768, respectively.

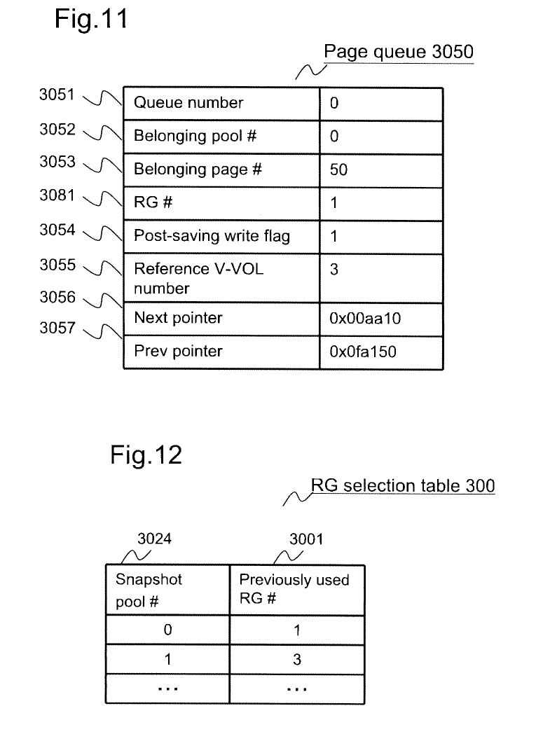

Thus, by dividing and managing the page queues 3050 belonging to RAID groups, it becomes possible to perform control so as to store differential data in the arbitrary RAID groups. Further, if differential data is stored in the page queue 3050, it means that the page queue is already used, so that it is connected to the entry of the relevant RG #3081 of the pool used queue table 313. On the other hand, if no differential data is stored in the page queue 3050, it means that the queue is a free queue, so that it is connected to the entry of the relevant RG #3081 of the pool free queue table 312. That is, the page queue 3050 is connected to either the pool free queue table 312 or the pool used queue table 313. The pool free queue table 312 is used to acquire an appropriate save destination for saving the differential data. The details of the page queue 3050 will be described with reference to FIG. 11.

FIG. 11 is a view showing the details of the page queue 3050 according to embodiment 1. The page queue 3050 is a table composed of a queue number 3051, a belonging pool #3052 (a belonging pool number), a belonging page # (a belonging page number) 3053, an RG #3081, a post-save write flag 3054, a reference V-VOL number 3055, a Next pointer 3056, and a Prey pointer 3057.

The queue number 3051 is a serial number for uniquely identifying the page queue 3050 in the storage system 100. The belonging pool #3052 is an identification number for uniquely identifying the snapshot pool 205 to which the relevant page queue 3050 belongs. This number can be the serial number of the snapshot pool 205 in the storage system 100.

The belonging page #3053 is a serial number of the capacity unit of the differential data (such as 64 KB or 256 KB) indicated by the relevant page queue 3050 in the snapshot pool 205 to which the page queue 3050 belongs. For example, if the storage system 100 has a 10 GB snapshot pool 205 and the capacity unit of the differential data is 64 KB, the belong page #3053 includes numbers from zero to 163839. It is impossible for a plurality of page queues 3050 belonging to the same snapshot pool 205 to have the same belonging page #3053.

The RG #3081 can be the same value as the RG # of the pool free queue table 312 or the RG # of the pool used queue table 313. The RG #3081 is information for checking whether the connection between the page queue and the pool free queue table 312 or the pool used queue table 313 is performed correctly. The post-save write flag 3054 is flag information indicating whether or not a host write request has been issued or not with respect to the V-VOL 202 referring to the relevant page. Further, the post-save write flag 3054 is turned ON (“1”) when a host write occurs to the V-VOL 202 during the preliminary saving process described later.

The reference V-VOL number 3055 is a counter information showing the number of V-VOLs 202 sharing the relevant page queue 3050. Upon saving the relevant page when a host write occurs to the P-VOL 201, a value of 1 or greater is stored according to the number of V-VOLs 202 sharing the relevant page to the reference V-VOL number 3055. The reference V-VOL 202 is reduced by triggers such as the cancelling of pairs or deleting of V-VOLs 202. The Next pointer 3056 and the Prey pointer 3057 are pointer information for realizing a queue structure by connecting mutual page queues 3050 or by connecting a page queue 3050 and a pool free queue table 312 or a pool used queue table 313.

FIG. 12 is a view showing an RG selection table 300 according to embodiment 1. The RG selection table 300 is a table composed of a snapshot pool #3024 and a previously used RG #3001. The present table is used to select a RAID group constituting a snapshot pool 205 as the destination for saving the differential data during the process for saving the differential data. The snapshot pool #3024 can be an identification number uniquely denoting the snapshot pool 205 in the storage system 100, and the value can be the same as the value in the snapshot pool #3024 of the pair information 302. The previously used RG #3001 shows the RAID group selected when the saving process of differential data for the relevant snapshot pool was performed previously.

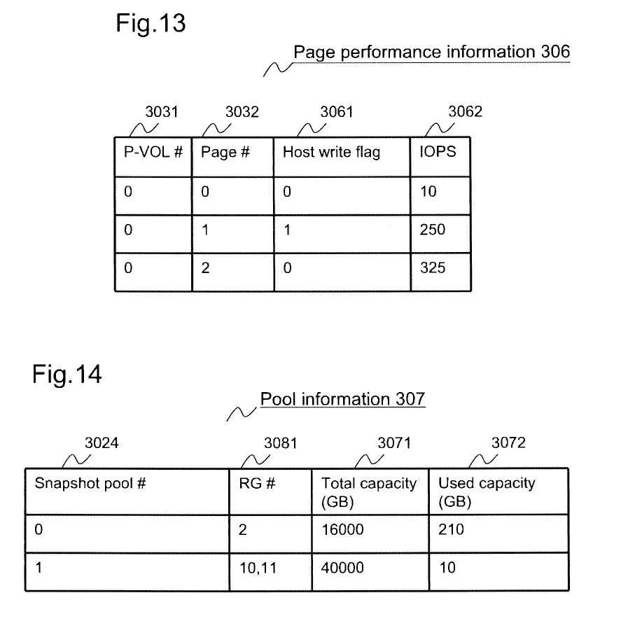

FIG. 13 shows a page performance information 306 according to the first embodiment. The page performance information 306 is a table managing the type and the amount of I/O received from the host for each P-VOL and for each page. The page performance information 306 is a table composed of a P-VOL #3031, a page #3032, a host write flag 3061, and an IOPS 3062. The P-VOL #3031 and the page #3032 can be the same information as the P-VOL #3031 and the page #3032 of the P-VOL differential information 303 (FIG. 8).

The host write flag 3061 is a flag information that is turned ON (“1”) when even a single write request has been issued from the host computer 10 to the relevant page of the P-VOL 201. The IOPS 3062 is the number of host I/Os received per second by the relevant page of the P-VOL 201. However, the TOPS 3062 can use other values as long as the amount of load per page is expressed. The use of the page performance information 306 is started via a specific trigger, and the information is updated at specific periodic cycles. The trigger for starting use and the periodic update cycle will be described in detail later.

FIG. 14 is a pool information 307 according to embodiment 1. The pool information 307 is a table for managing the status of the snapshot pool 205 in the storage system 100. The pool information 307 is a table composed of a snapshot pool #3024, an RG #3081, a total capacity (GB) 3071 and a used capacity (GB) 3072.

The snapshot pool #3024 can be an identification number for uniquely identifying the snapshot pool in the storage system 100, which can be the same value as the snapshot pool #3024 of the pair information 302 (FIG. 7). The RG #3081 is an identification number for uniquely identifying the RAID group constituting the snapshot pool 205, which can be the same value as the RG #3081 of the RAID group information 308 (FIG. 5).

The total capacity (GB) 3071 shows the overall capacity of the relevant snapshot pool 205. In the present example, the capacity is expressed by entering a numerical value of GB units, but expressions other than using GB units are possible. The used capacity (GB) 3072 shows the capacity being used in the relevant snapshot pool 205. The capacity is shown in GB units according to the present example, but expressions other than GB units, such as TB units or percentage, are also possible.

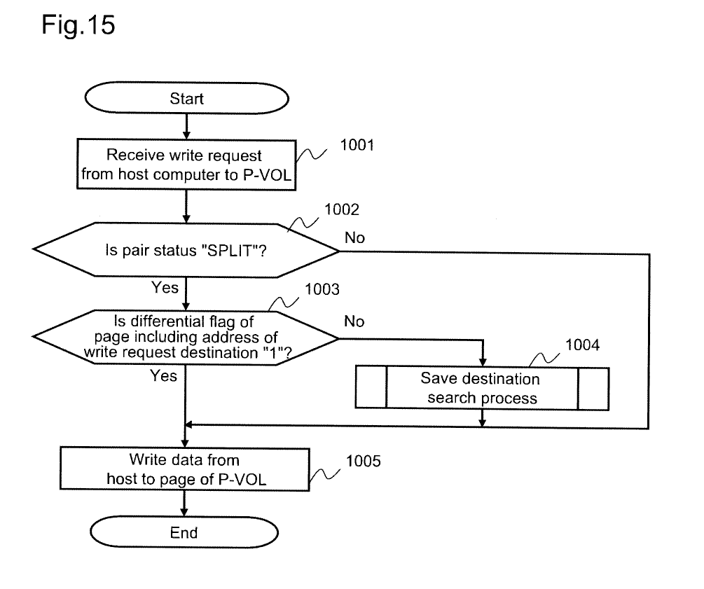

FIG. 15 is a flowchart showing a host write process of the P-VOL 201 according to embodiment 1. According to the flowcharts in the present description, the processes are mainly executed via the processor 103 of the storage system 100 unless indicated otherwise, but the processes are not restricted to execution via the processor 103. According further to the description, the host I/O to defective pairs in “FAILURE” status, for example, is not possible.

The storage system 100 receives a write request to the P-VOL from the host computer 10 (step 1001). Next, the processor 103 refers to the pair information 302, and determines whether the pair status 3023 of the relevant P-VOL 201 is “SPLIT” or not (step 1002). If the result of the determination is “No”, that is, if the pair status is “PAIRED”, the procedure advances to step 1005. If the result of the determination in step 1002 is “Yes”, that is, if the pair status is “SPLIT”, the processor 103 determines whether the value of the differential flag 3033 of the P-VOL differential information 303 is “1” or not (step 1003). If the result of the determination is “Yes”, that is, if the differential flag 3033 is “1”, the procedure advances to step 1005.

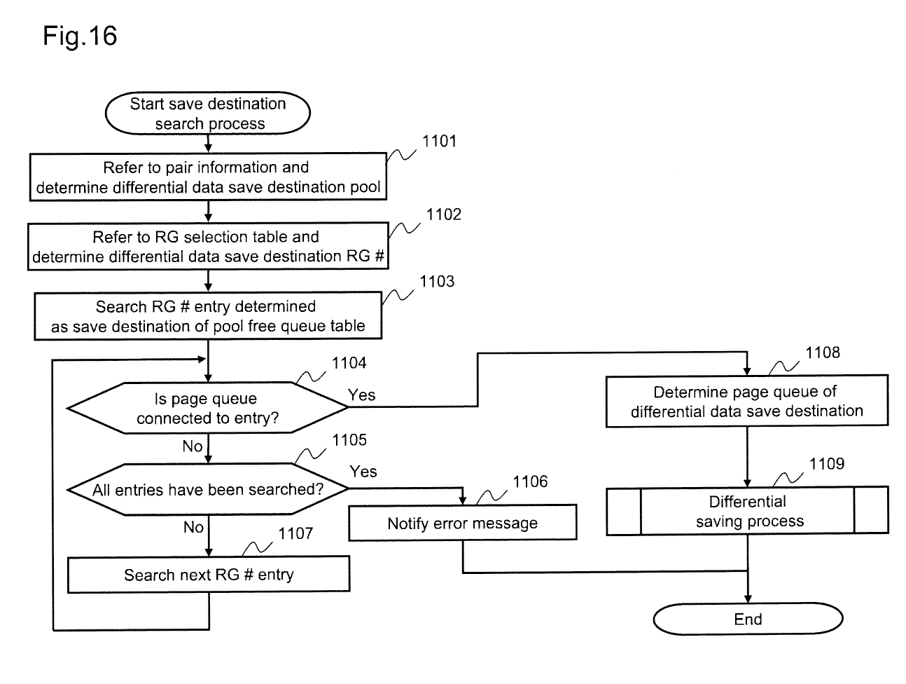

If the result of determination in step 1003 is “NO”, that is, if the differential flag 3033 is “0”, the procedure advances to a save destination search process shown in step 1004. The details of the save destination search process will be described with reference to FIG. 16. When the save destination search process shown in step 1004 is completed, the procedure advances to step 1005. In step 1005, the processor 103 writes the write data received from the host to the page of the P-VOL 201. Then, the host write operation of the P-VOL 201 is ended.

Next, the details of the save destination search process will be described with reference to FIG. 16. FIG. 16 is a flowchart showing the details of the save destination search process according to embodiment 1. At first, the processor 103 refers to a snapshot pool #3024 of the relevant P-VOL 202 of the pair information 302. and determines the save destination snapshot pool 205 (step 1101).

Next, the processor 103 refers to the previously used RG #3001 of the relevant snapshot pool 205 of the RG selection table 300, and determines the RG # to be used for saving the current differential data (step 1102). According to the present embodiment, the RG # is determined in a round-robin fashion. That is, if there are multiple RAID groups constituting the relevant snapshot pool 205, each of the multiple RAID groups are used sequentially in order as the destination for saving differential data. Thus, it becomes possible to prevent differential data from concentrating to a specific RAID group.

Next, the processor 103 refers to the pool free queue table 312. At this time, the processor 103 searches the queue of the entry of the RG # determined in step 1102 (step 1103). Thereafter, the processor 103 determines whether the entry searched in step 1103 has a page queue 3050 connected thereto or not (step 1104). If as a result of determination in step 1104 a page queue 3050 is connected to the entry of the RG # (“Yes” in step 1104), the processor 103 determines the page queue 3050 as the destination for saving the differential data (step 1108).

If as a result of determination in step 1104 a page queue 3050 is not connected to the entry of the RG #, the procedure advances to step 1105 (“No” in step 1104). In step 1105, the processor 103 determines whether the entries of all the RG # in the pool free queue table 312 has been searched or not. If as a result of the determination there is an entry of an RG # that has not been searched (“No” in step 1104), the procedure advances to step 1107. Step 1107 is a process for searching the entry of the next RG # of the entry of the RG # having been previously searched. If the entry of the RG # has reached the terminal end, it is possible to perform control to search the entry of the leading RG #. The processor 103 searches the entry of the next RG #, and returns to the determination process of step 1104 again.

On the other hand, if the result of determination of step 1105 is “Yes”, it means that the entries of all the RG # has been searched but there was no page queue 3050 connected to the entries of the RG #. In other words, there is no page queue in the pool free queue table 312, and that the relevant snapshot pool 205 is in a state not enabling differential data to be saved thereto. Therefore, in step 1106 the processor 103 sends an error message to the administrator and ends the present process.

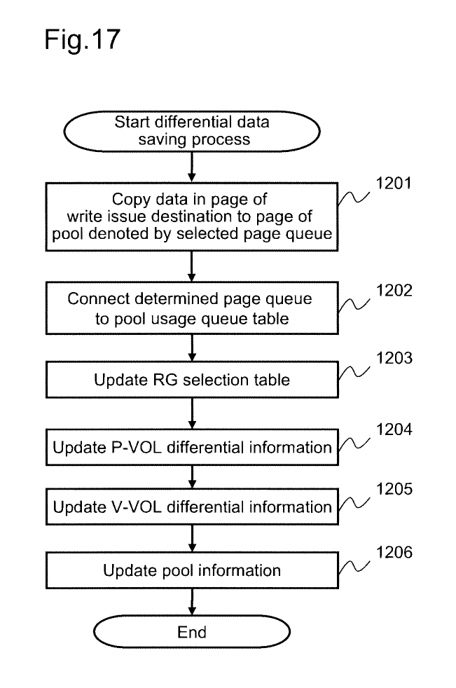

Lastly, the process subsequent to step 1108 will be described. In step 1108, the page queue 3050 to be used as the destination for saving the differential data is determined, and thereafter, the procedure advances to a differential saving process shown in step 1109. The details of the differential saving process will be described in a different drawing (FIG. 17). After the differential saving process of step 1109 is completed, the save destination search process is ended.

Next, the details of the differential saving process will be described with reference to FIG. 17. FIG. 17 is a flowchart showing the details of the differential saving process according to embodiment 1. First, the processor 103 copies the data within the relevant page of the P-VOL 201 being the host-write issue destination to a page of the snapshot pool 205 shown by the page queue 3050 determined in step 1108 of FIG. 16 (step 1201).

Next, the processor 103 changes the connection of the page queue 3050 determined in step 1108 of FIG. 16 from the pool free queue table 312 to the pool used queue table 313 (step 1202). At this time, the connection destination entry to the pool used queue table 313 is determined to be the entry of the same RG # as that connected to the pool free queue table 312.

Next, the processor 103 updates the RG selection table 300 (step 1203). Actually, the contents of the previously used RG #3001 of the RG selection table 300 should be updated to the RG # used for the present differential data saving process.

Next, the processor 103 updates the P-VOL differential information 303 (step 1204). Actually, if differential data has been generated between the relevant P-VOL 201 and all the V-VOLs 202 created from the relevant P-VOL 201, the differential flag 3033 of the P-VOL differential information 303 is set from “0” to “1”.

Thereafter, the processor 103 updates the V-VOL differential information 304 (step 1205). Actually, the differential flag 3041, the shared V-VOL #3042 and the reference destination address 3043 of the V-VOL differential information 304 are respectively updated. The shared V-VOL #3042 is updated when another V-VOL 202 sharing the differential data of the relevant page exists. A belonging pool #3052 and a belonging page #3053 denoted by the page queue 3050 determined in step 1108 should be set as the reference destination address 3043. The differential flag 3041 is changed from “0” to “1” regarding the V-VOL 202 which is in a “SPLIT” state with the relevant P-VOL 201.

Next, the processor 103 updates the pool information 307 (step 1206). Here, the used capacity (GB) 3072 of the pool information 307 is updated. The used capacity of the snapshot pool 205 is increased by saving the differential data, so that the used capacity should be set by calculating the increased capacity. The differential saving process is ended by the above-described steps. The above-described process is a so-called CoW (Copy-on-Write) process for copying the original data to the snapshot pool during a host write process.

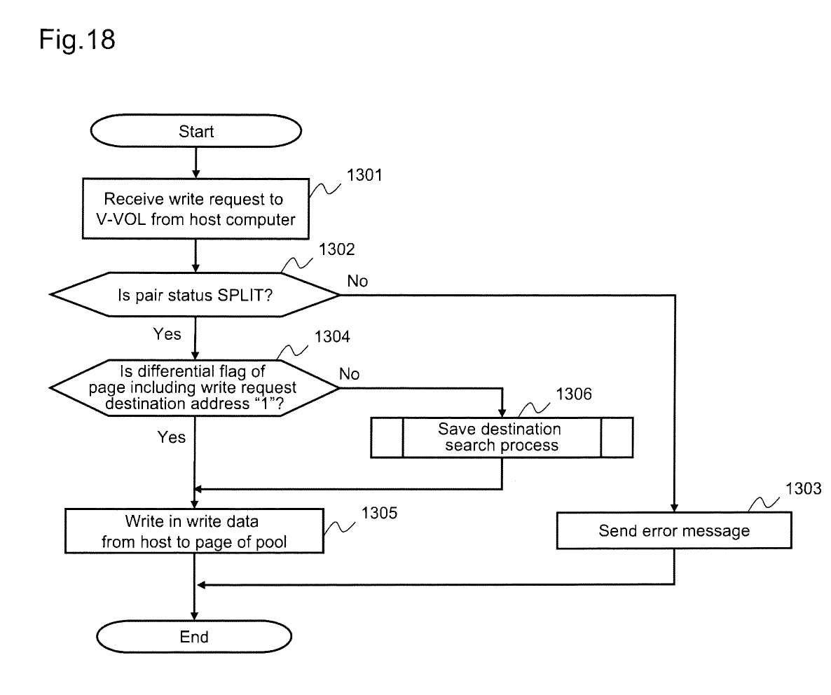

Next, the host write process to the V-VOL 202 will be described with reference to FIG. 18. FIG. 18 is a flowchart showing the host write process to the V-VOL 202 according to embodiment 1. The storage system 100 receives a write request from the host computer 10 to the V-VOL 202 (step 1301).

Next, the processor 103 refers to the pair information 302, and determines whether the pair status 3023 of the relevant V-VOL 202 is “SPLIT” or not (step 1302). If the result of the determination is “NO”, that is, if the pair status is “PAIRED”, the procedure advances to step 1303. In step 1303, the processor 103 notifies an error message to the host computer 10 or the administrator, and ends the process. This is because the V-VOL 202 cannot be updated since the pair status thereof is “PAIRED”, that is, the V-VOL 202 is in a corresponding state with the P-VOL 201.

If the result of determination of step 1302 is “Yes”, that is, if the pair status is “SPLIT”, the processor 103 determines whether the value of the differential flag 3041 of the V-VOL differential information 304 is “1” or not (step 1304). If the result of the determination is “Yes”, that is, if the differential flag 3041 is “1”, the procedure advances to step 1305 since the differential data is already saved. In step 1305 the processor 103 writes the write data received from the host computer 10 to a page denoted by the reference destination address 3043 of the V-VOL differential information 304.

If the result of determination of step 1304 is “NO”, it means that the differential data is not yet saved, so that the procedure advances to the save destination search process shown in step 1306. If the save destination search process is completed, the procedure advances to step 1305, and the processor 103 ends the process.

As described, the host write operation to the V-VOL 202 is completed. The flow of the save destination search process according to the host write process of V-VOL 202 can be the same as the host write operation to the P-VOL 201. However, the updating process of the P-VOL differential information 303 during the differential data saving process differs. Actually, there is no need to update the P-VOL differential information 304. The above-mentioned process is also a CoW process since the original data is copied to the snapshot pool during a host writing process similar to FIG. 15.

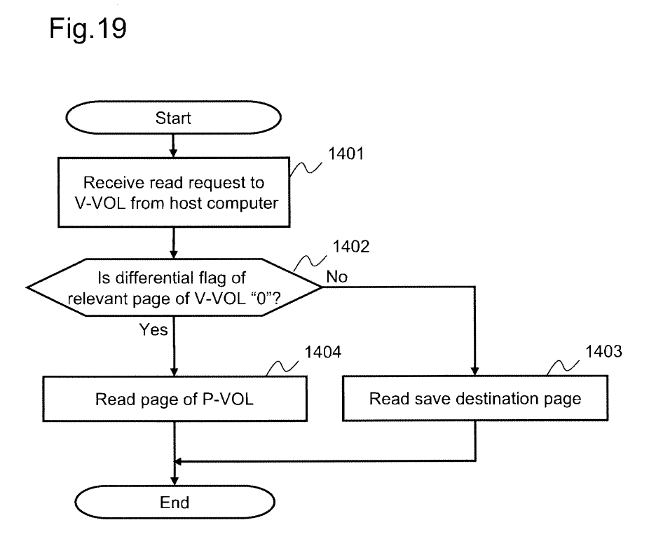

Next, the host read process of the V-VOL 202 will be described with reference to FIG. 19. FIG. 19 is a flowchart of the host read process of the V-VOL 202 according to embodiment 1. The storage system 100 receives a read request from the host computer 10 to the V-VOL 202 (step 1401).

Next, the processor 103 determines whether the relevant differential flag 3041 of the V-VOL differential information 304 is “0” or not (step 1402). If the result of determination is “NO”, that is, if the differential flag 3041 is “1”, the procedure is advanced to step 1403. In 1403, the processor 103 refers to the relevant reference destination address 3043 of the V-VOL differential information 304, specifies the identification number and the page of the snapshot pool 205 in which the differential data is saved, reads the differential data in the specified page, and ends the process.

If the result of determination in step 1402 is “Yes”, that is, if the differential flag 3042 of the V-VOL differential information 304 is “0”, the processor 103 reads the page of the P-VOL 201 (step 1404) and ends the process. By the steps mentioned above, the host read process of V-VOL 202 is ended.

Next, the problem that the present embodiment aims to solve will be described once again. A method for providing a snapshot volume (V-VOL 202) as an OS image disk of the VM 12 has been provided as a new purpose of use of the snapshot function, which has conventionally been used for backup.

In the actual system, a V-VOL 202 is created using a snapshot function from the P-VOL 201 storing original data such as the OS or application program (AP), and the V-VOL 202 is provided as a volume of the VM 12. This system is advantageous since a large amount of VMs can be created, operated and managed at high speed, but if the large number of VMs 12 are started concurrently, there is a drawback that the reading and writing of the V-VOL 202 occurs frequently. Especially, when writing data to the V-VOL 202, a large number of saving processes of differential data occurs. The process for saving differential data burdens the storage system 100 since a process overhead for reading the original data from the P-VOL 201 and writing the same to the snapshot pool 205 must be performed in addition to the normal write process. Therefore, in order to solve this problem, embodiment 1 of the present invention performs a process to save the original data in advance prior to starting the VM.

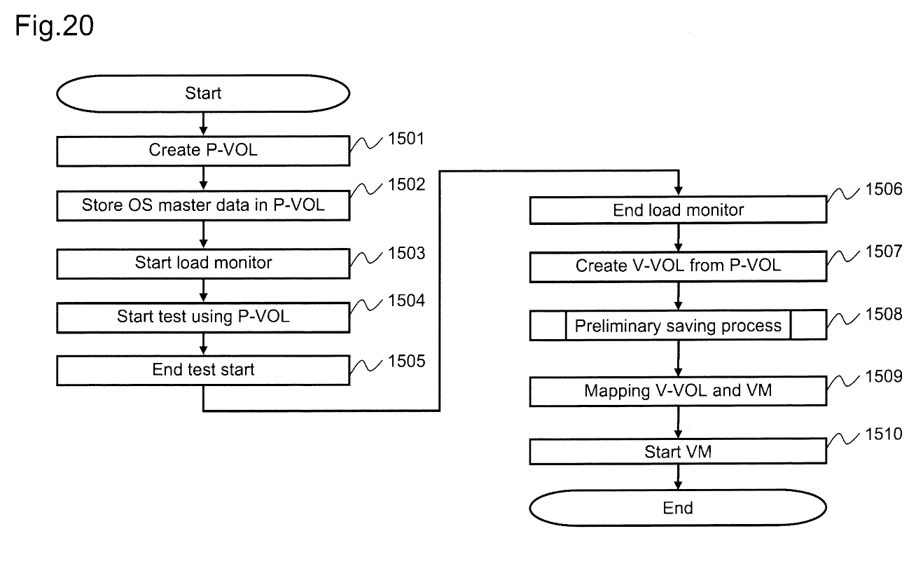

FIG. 20 illustrates the flow of the VM starting process according to embodiment 1. The user including the system administrator orders the storage controller 101 to create a P-VOL 201 via the management computer 11, and based thereon, the processor 103 creates the designated P-VOL 201 (step 1501). Next, the user orders the storage controller 101 to mount the created P-VOL 201 on the host computer 10 or the management computer 11 via the management computer 11, and based thereon, the processor 103 allocates the created P-VOL 201 to the host computer 10 or the management computer 11. Thereafter, the user stores the master data of the OS to the created P-VOL 201 via the host computer 10 or the management computer 11 (step 1502). Then, the user orders the storage controller 101 to start a load monitoring process via the management computer 11, and based thereon, the processor 103 starts a load monitoring program (step 1503).

When the processor 103 starts the load monitoring process, the processor 103 measures the load of each page unit with respect to the P-VOL 201 included in the storage system 100. The item of measurement is the number of I/Os received respectively as host read request and host write request, and if a page receives even a single host write request, the host write flag 3061 of the page performance information 306 is updated from “0” to “1”. Further, the processor 103 writes the number of I/Os received within a unit time to the TOPS 3061 of the page performance information 306 regardless of whether the type of I/O is a host read request or a host write request. The processor 103 performs the above-mentioned measurement and the update of the page performance information until the storage controller 101 receives a request to terminate the load monitoring process from the user.

Next, the user performs a test start process using the P-VOL 201 having stored the master data via the host computer 10 or the management computer 11 (step 1504). The test start is performed by simply starting the OS in a normal manner. Thereafter, the user ends the test start process (step 1505). Next, the user orders the storage controller 101 to end the load monitoring process via the management computer 11 (step 1506).

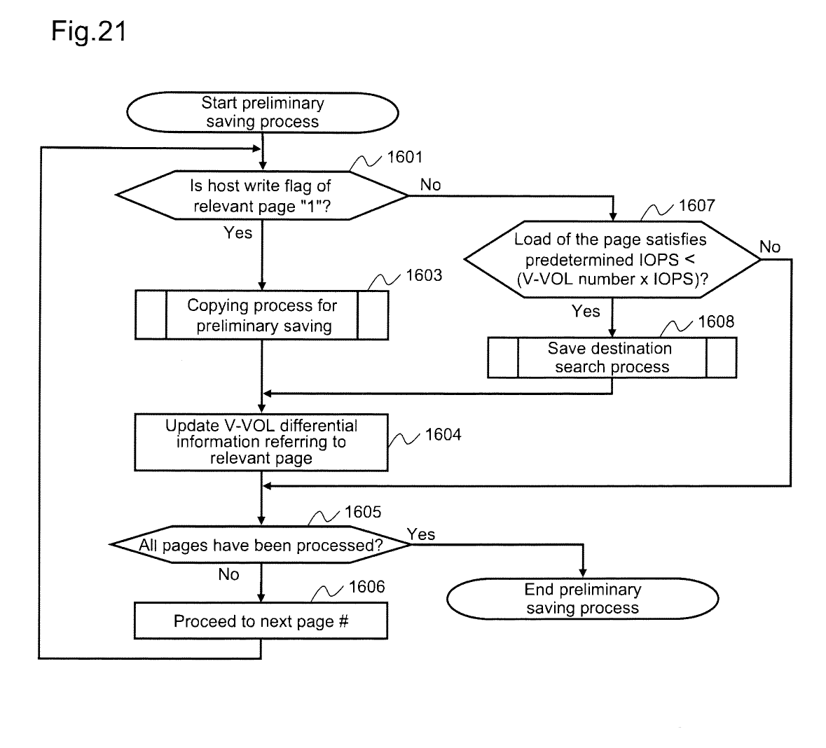

Thereafter, the user orders the storage controller 101 to create a V-VOL 202 from the P-VOL 201 using a snapshot function via the management computer 11, and based thereon, the processor 103 creates a V-VOL 202 from the P-VOL 201. At this time, the user can designate the number of V-VOLs 202 created from the P-VOL 201, and if the number is not designated by the user, the storage controller can create a predetermined number of V-VOLs automatically (step 1507). Next, the processor 103 performs the preliminary saving process (step 1508). The preliminary saving process will be described in detail with respect to a separate drawing (FIG. 21). Next, the user orders the storage controller 101 to map the created V-VOLs 202 and the VMs 12 via the management computer 11, and based thereon, the processor 103 maps the V-VOLs 202 and the VMs 12 (step 1509).

Lastly, the user starts the VM 12 using the mapped V-VOL 202 (step 1510), and ends the process. Further, if the data stored in the P-VOL 201 is an OS data having installed a specific application program, the period for performing the test start process is set from the starting of the OS to the starting of the application program, and the speed of the process for starting the application program can be enhanced.

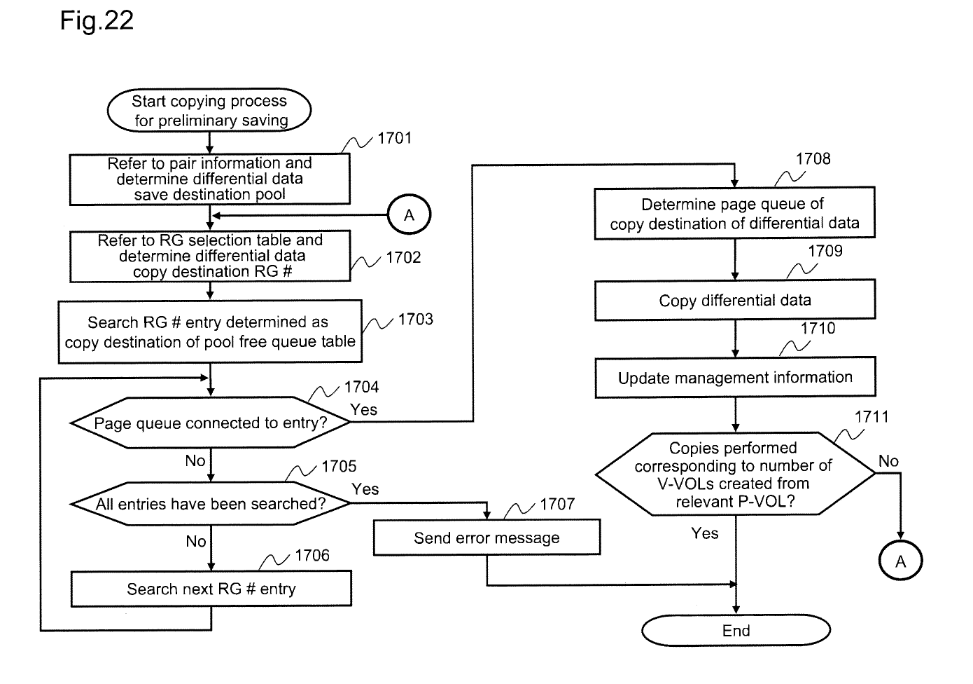

Next, the preliminary saving process will be described with reference to FIG. 21. The processor 103 determines whether the host write flag 3061 is “1” or not from the leading page #3032 of the page performance information 306 (step 1601). If the result of determination is “Yes” (“1”), the procedure advances to step 1603. In step 1603, the processor 103 executes a copying process for preliminary saving. The details of the copying process for preliminary saving will be described with reference to a separate drawing (FIG. 22).

Next, the procedure advances to step 1604. In step 1604, the processor 103 updates the differential flag 3041 and the reference destination address 3043 of the V-VOL differential information 304. Actually, the processor 103 updates the differential flag 3041 of the relevant page portion referring to the differential data either saved or copied in step 1603 from “0” to “1”.

As for the reference destination address 3043, the processor 103 similarly writes the save destination and copy destination snapshot pool # (snapshot pool number) and the page # (page number) determined in step 1603. The procedure advances to step 1605, where it is determined whether step 1601 has been performed for all the pages of the relevant P-VOL 201. If the result of determination of step 1605 is “Yes”, the preliminary saving process is ended.

If the result of determination of step 1605 is “NO”, the processor 103 refers to the page performance information 303, and advances to the next entry of the page #3032 (step 1606), where the procedure returns to step 1601. If the result of determination in step 1601 is “NO”, the procedure advances to step 1607. In step 1607, the processor 103 refers to the IOPS (Input Output Per Second) 3062 of the page performance information 306, and determines whether the product of the value of the IOPS 3062 to the relevant page and the number of V-VOls 202 created from the relevant P-VOL exceeds a predetermined IOPS or not. The present description refers to a case in which a host write request is not issued to the relevant page, so that during actual starting of the VM, obviously, the CoW process does not occur.

However, the page to which the host write request is not issued is a page having a possibility that a large number of V-VOLs 202 may continue referring to the relevant P-VOL 201, and that the large amount of concentrated I/O to the P-VOL 201 may become the bottleneck of the performance. Therefore, even if the page does not have a host write request issued thereto, if the product of the number of V-VOLs 202 referring thereto and the IOPS that the respective V-VOLs 202 receive exceeds a predetermined value, or simply if the TOPS that the relevant page receives exceeds a predetermined value, the processor 103 saves the relevant page in the snapshot pool 205, and sets the relevant page of the relevant V-VOL 202 to refer to the snapshot pool 205. Thus, even if the page does not have any write request issued thereto, the page having a heavy load will have its load dispersed within the snapshot pool 205, so that the concentration of load to the P-VOL 201 can be prevented.

If the result of determination in step 1607 is “Yes”, the procedure advances to step 1608. In step 1608, the save destination search process is performed. The procedure of the save destination search process 1608 is the same as the procedure of the save destination search process of FIG. 16. Thereafter, the procedure advances to step 1604. If the result of determination in step 1607 is “NO”, the procedure advances to step 1605.

Next, the details of the copying process for preliminary saving (step 1603) will be described with reference to FIG. 22. The processor 103 refers to the snapshot pool #3024 of the pair information 302, and determines the snapshot pool 205 of the destination for copying the differential data (step 1701).

Thereafter, the processor 103 refers to the previously used RG #3001 of the RG selection table 300, and specifies the RG # selected in the previous differential data saving process or the copying process. Next, the processor 103 refers to the RG #3081 of the pool information 307. If the snapshot pool 205 being the target of the differential data saving process is composed of a plurality of RAID groups, the RAID group subsequent to the RAID group denoted by the previously used RG #3001 is determined as the copy destination RAID group of the current differential data (step 1702).

Thereafter, the processor 103 searches the entry denoted by the RAID group specified in step 1702 from the pool free queue table 312 (step 1703). Next, the processor 103 determines whether a page queue 3050 is connected to the entry searched in step 1703 (step 1704). If the result of determination is “Yes”, that is, if a page queue 3050 is connected to the entry, the processor 103 determines the page queue 3050 connected thereto to the destination for copying the differential data (step 1708).

Next, the processor 103 copies the differential data to the snapshot pool # and the page # denoted by the page queue 3050 determined in step 1708 (step 1709). Then, the processor 103 updates the relevant reference destination address #3043 of the V-VOL differential information 304 to the belonging pool #3052 and the belonging page #3053 of the snapshot denoted by the page queue 3050 copied in step 1709. Further, the used capacity (GB) 3071 of the pool information 307 is also updated (step 1710). In step 1710, the management information is updated so that the respective V-VOLs 202 created from the P-VOL 201 exclusively possess the copied differential data.

Next, the processor 103 determines whether the process for copying the differential data according to the above step is performed for the same number of times as the number of V-VOLs 202 created from the P-VOL 201 (step 1711). If the result of the determination is “Yes”, the process is ended. If the result of determination is “No”, the procedure returns to step 1702. If the determination result of step 1704 is “No”, the procedure advances to step 1705. The steps 1705, 1706 and 1707 are the same as steps 1105, 1107 and 1106 of FIG. 16.

According to the respective steps mentioned above, the copying process for preliminary saving is realized. According to the present process, it is necessary to repeatedly perform the copying process for preliminary saving for a number of times corresponding to the number of V-VOLs 202 created from the relevant P-VOL 201. However, it is possible for the administrator to enter the number of VMs 12 to be started to the storage system 100 via the management computer 11 or the like, and to set the number of times for performing the copying process for preliminary saving as the number of VMs 12 entered by the administrator. In that case, the number of VMs 12 can be entered via a VM setup screen 40 shown in FIG. 32.

FIG. 32 is a configuration showing the VM setup screen 40. The VM setup screen 40 is a management screen displayed on the management computer 11 connected to the storage system 100, and is composed of a table 400 for setting up the number of VMs to be started, an enter button 403, and a cancel button 404. The table 400 for setting up the number of VMs to be started is a table composed of a P-VOL number 401 and a scheduled number of VMs to be created 402.

The administrator is capable of entering the P-VOL number 401 and the scheduled number of VMs to be created 402 in the starting VM number setup table 400. Prior to creating the V-VOLs to be mapped to the VM 12, the administrator enters a value to the scheduled number of VMs to be created 402 and presses the enter button 403. Thus, the number of VMs scheduled to be mapped to the V-VOLs created from the relevant P-VOL can be notified to the storage system 100. In this case, according to step 1711, the processor 103 is merely required to determine whether the copying process of differential data has been performed for a number of times equal to the number entered to the scheduled number of VMs to be created 402. The details of the preliminary saving process via page units has been explained.

Next, we will describe the process of deleting the copy data of the differential data created via the preliminary saving process. According to the prior art snapshot, the differential data generated between the P-VOL 201 and the V-VOL 202 is saved in the snapshot pool 205. In other words, when a host write request is issued to the P-VOL 201 or the V-VOL 202 and differential data occurs thereby, differential data must be saved. The differential data can be deleted from the snapshot pool 205 triggered by the deleting of the V-VOL 202 or the changing of the pair status to “PAIRED”.

According to the present invention, the page that may become differential data is saved or copied to the snapshot pool 205 in advance prior to the issue of a host write request, so that it is necessary to consider a process for deleting the data saved in the snapshot pool 205 including the data saved in the snapshot pool 205 but not actually used as differential data.

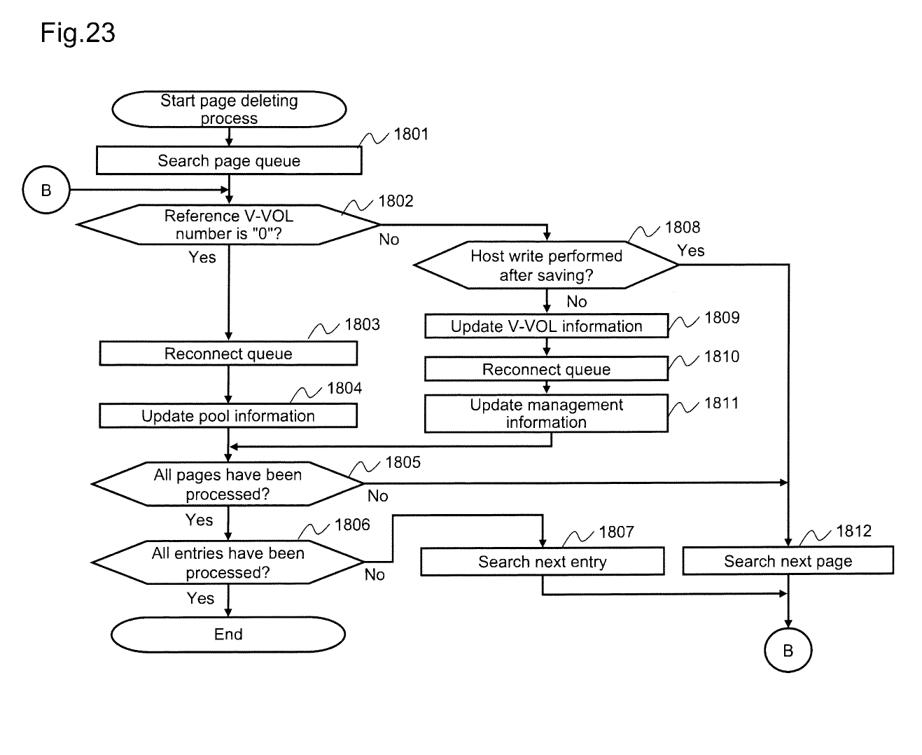

FIG. 23 is a flowchart illustrating the process for deleting a page saved or copied in the preliminary saving process according to embodiment 1. First, the processor 103 searches the pool used queue table 313 (step 1801).

Next, the processor 103 determines whether the value of the reference V-VOL number 3055 is “0” or not with respect to the searched page queue 3050 (step 1802). If the result of the determination in step 1802 is “Yes” (“0”), the processor 103 reconnects the relevant page queue 3050 to the pool free queue table 312 and frees the area of the relevant page of the snapshot pool 205 (step 1803). One actual possible example in which the determination result in step 1802 is “Yes” is a case where the created V-VOL 202 is deleted and there is no more V-VOLs 202 referring to the relevant page.

Thereafter, the processor 103 updates the used capacity (GB) 3072 of the pool information 307 (step 1804). Next, the processor 103 determines whether all the page queues 3050 belonging to the relevant entry of the pool used queue table 313 has been processed or not (step 1805). If the result of the determination in step 1805 is “Yes”, the processor 103 determines whether all the entries of the pool used queue table 313 has been processed or not (step 1806).

If the result of determination in step 1806 is “Yes”, the process is ended. If the result of the determination in step 1806 is “No”, the processor 103 searches the next entry of the pool used queue table 313 (step 1807), and returns to step 1802. If the result of determination in step 1805 is “No”, the processor 103 searches the next page of the pool used queue table 313 (step 1812) and returns to step 1802.

If the result of determination in step 1802 is “No”, the processor 103 refers to a post-save write flag 3054 of the relevant page queue 3050 and determines whether a host write request has been issued after saving (step 1808). If the result of determination in step 1808 is “No”, the processor 103 updates the reference destination address 3043 of the V-VOL differential information 304 to “NULL” (step 1809). Here, the relevant page queue 3050 is saved but a host write request has not been received, so the data of the relevant page queue 3050 and the data in the page of the P-VOL 201 are the same. Therefore, the processor 103 changes the reference destination of the V-VOL 202 referring to the relevant page queue 3050 to the P-VOL 201.

Next, the processor 103 changes the corresponding relationship with the relevant page queue 3050 from the pool used queue 313 to a pool free queue 312 (step 1810), and updates the used capacity (GB) 3072 of the pool information 307 (step 1811). Next, the procedure advances to step 1805. If the result of determination of step 1808 is “Yes”, the procedure advances to step 1812. The above-described steps realize the process for deleting saved pages.

Incidentally, the trigger for performing the deleting process illustrated in FIG. 23 can be set to when the used capacity of the snapshot pool 205 exceeds a predetermined value. Other possible triggers include an arbitrarily timing at which the user or the administrator orders the deleting process to the storage system 100 via the management computer 11, or a scheduled timing of the deleting process determined via the management computer 11. Since the deleing process itself is a process that places a certain level of burden on the storage system 100, it is possible to perform the process when the amount of load (IOPS) respectively placed on the storage system 100, the P-VOL 201 and the snapshot pool 205 falls below a predetermined value. Further, the trigger for performing the deleting process can be set to after performing step 1510 illustrated in FIG. 20.

Next, the host write process to the V-VOL 202 after performing the preliminary saving process will be described. The host read process and the host write process of the P-VOL 201 after the preliminary saving process are the same as in the case without the preliminary saving process, so detailed descriptions thereof are omitted. The host read process of the V-VOL 202 after the preliminary saving process is also the same as the case without the preliminary saving process, so detailed descriptions thereof are omitted.

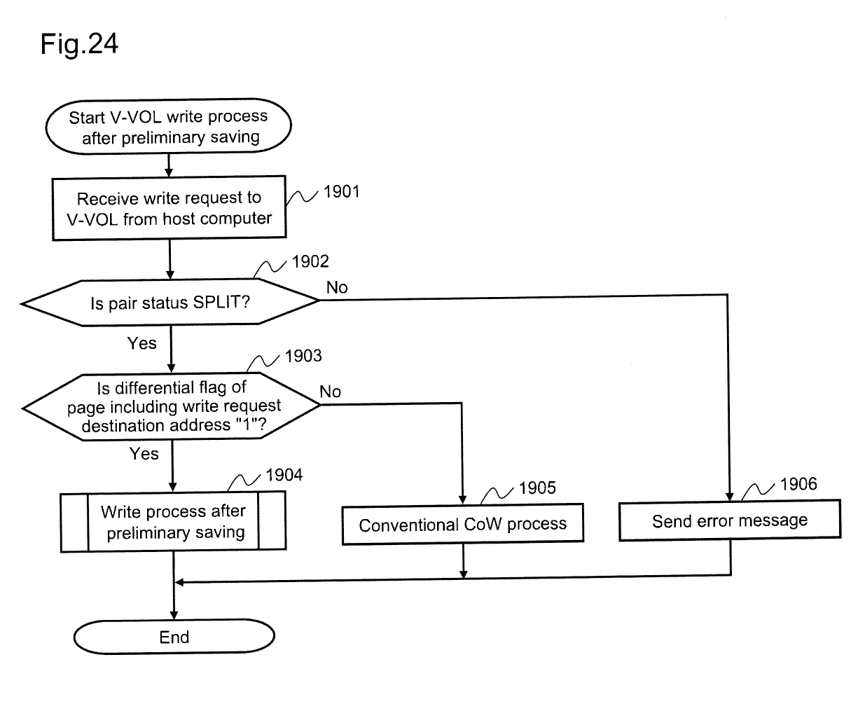

FIGS. 24 through 26 are used to describe the host write process of the V-VOL 202 after the preliminary saving process. FIG. 24 is a flowchart illustrating the host write process performed to the V-VOL 202 after the preliminary saving process. First, the storage system 100 receives a write request from the host computer 10 to the V-VOL 202 (step 1901).

Next, the processor 103 refers to the pair information 302, and determines the pair status of the relevant V-VOL (step 1902). If the result of the determination is “No”, that is, if the pair status is “PAIRED”, the procedure advances to step 1906. In step 1906, the processor 103 sends an error message to the host computer 10 or the administrator, and ends the process.

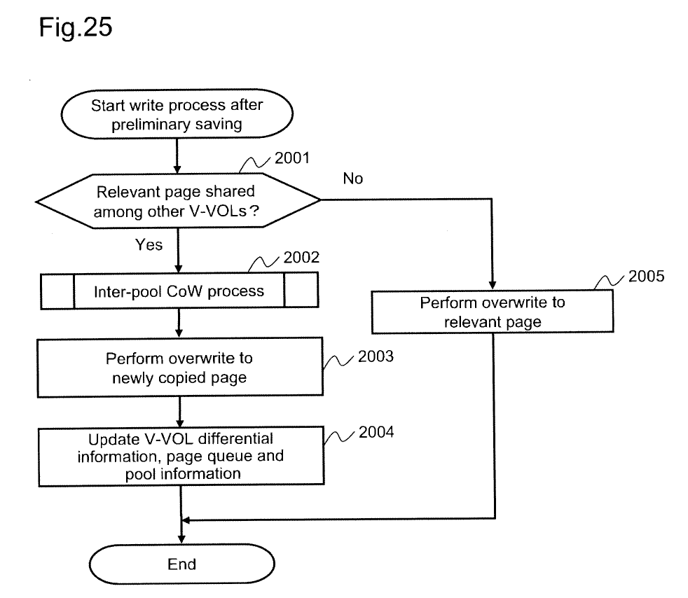

If the result of determination of step 1902 is “Yes”, that is, if the pair status is “SPLIT”, the processor 103 determines whether the value of the differential flag 3041 of the V-VOL differential information 304 is “1” or not (step 1903). If the result of the determination is “Yes” (“1”), that is, if the differential flag is “1”, it means that differential data is already saved, so that the procedure advances to step 1904. In step 1904, the processor 103 performs the write process to the V-VOL 202 after the preliminary saving process, and the details of the process will be described with reference to FIG. 25. If the result of the determination is “No”, the processor 103 performs the same CoW process as according to the prior art (step 1905).

Next, the details of the write process to the V-VOL after preliminary saving will be described with reference to FIG. 25. FIG. 25 is a flowchart of the write process after preliminary saving. First, the processor 103 refers to the shared V-VOL #3042 in the relevant page of the V-VOL differential information 304, and determines whether other V-VOLs 202 sharing the relevant page exist or not (step 2001). If the result of the determination is “No”, the processor 103 overwrites the host data to the relevant page (step 2005), and ends the process.

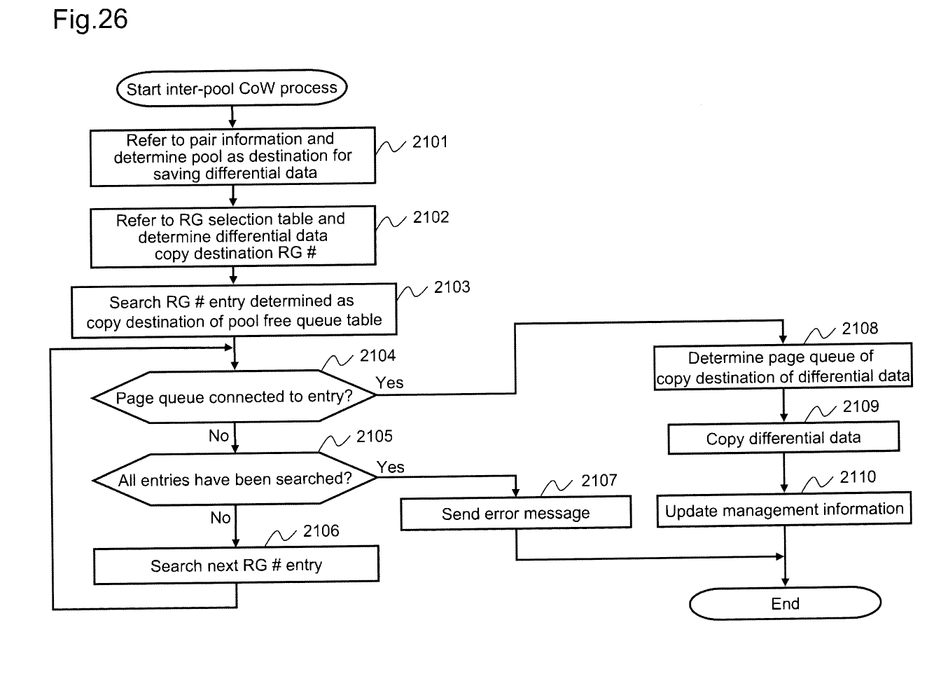

If the result of determination in step 2001 is “Yes”, the procedure advances to an inter-pool CoW (Copy-on-Write) process (step 2002). The details of the inter-pool CoW (Copy-on-Write) process will be described with reference to FIG. 26. Next, the processor 103 overwrites the host write data on the page newly copied in the snapshot pool 205 in step 2002 (step 2003). Thereafter, the processor 103 updates the shared V-VOL #3042 of the V-VOL differential information 304 to “NULL”, updates the reference destination address 3043 to the new page, updates the post-save write flag 3054 of the relevant page queue 3050 to “1”, decrements the reference V-VOL number 3055, updates the contents of the pool information 307 (FIG. 14) (step 2004), and ends the process.

Subsequently, the details of the inter-pool CoW (Copy-on-Write) process will be described with reference to FIG. 26. FIG. 26 is a flowchart of the inter-pool CoW process. The process of FIG. 26 is similar to the process of FIG. 22, and the only two differences of the present process from FIG. 22 are that the determination process of step 1711 is not necessary and that the copy source of the differential data copied in step 2109 is the page denoted by the relevant page queue 3050 within the same pool.

The first embodiment of the present invention has been described. The effects of embodiment 1 will now be described. Embodiment 1 enables to enhance the speed of starting the OS or the application of the VM 12 mounting the V-VOL 202 by subjecting the P-VOL 201 storing the OS data or the OS data and the application program data to test starting, performance measurement and preliminary saving. Especially in the case where a host write request is issued during starting of the OS or the starting of the application program, a normal write operation creating only a small load can be performed instead of the burdensome CoW (Copy-on-Write) operation that had been indispensible according to the prior art system, and therefore, the present embodiment enables to reduce the load of the overall storage system and to enhance the speed of starting the VM.

### Embodiment 2

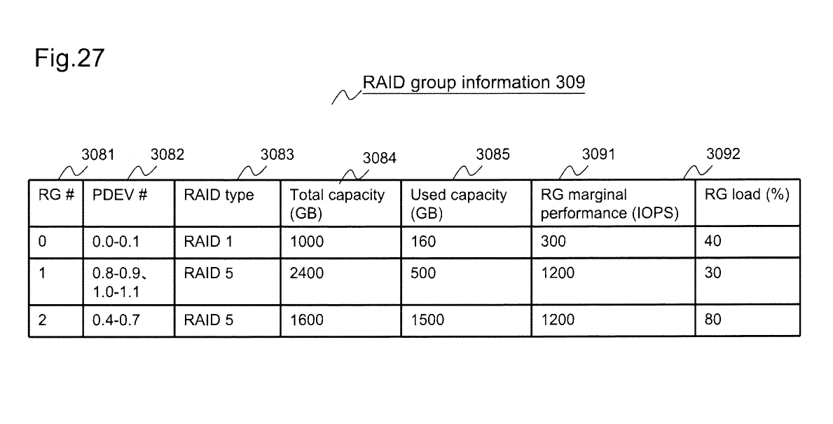

Now, the second embodiment of the present invention will be described with reference to FIGS. 27 through 29. Embodiment 2 has further devised the save destination search process of embodiment 1 described in FIG. 22, and searches a save destination so that the performances of RAID groups constituting the snapshot pool 205 are uniformized. The details of the process will now be described.

FIG. 27 is a view showing a RAID group information 309 according to embodiment 2. The RAID group information 309 is a table composed of an RG #3081, a PDEV #3082, a RAID type 3083, a total capacity (GB) 3084, a used capacity (GB) 3085, an RG marginal performance (IOPS) 3091, and an RG load (%) 3092.

Further, the RAID group information 309 has added the RG marginal performance (IOPS) 3091 and the RG load (%) 3092 to the RAID group information 308 described in embodiment 1. The RG marginal performance (IOPS) 3091 shows the marginal performance of the relevant RAID group in IOPS (I/O per second), which can be calculated based on the storage media types constituting the RAID group, the number of media therein and the RAID type.

For example, if the RAID group is composed of four HDDS having a marginal performance of 300 TOPS and having a RAID5 arrangement, the marginal performance of the relevant RAID group becomes 1200 TOPS (300 TOPS×4). The RG load (%) refers to the total amount of load that the RAID group receives shown by percentage, which can be calculated by dividing the value of the RG marginal performance (IOPS) 3091 by the number of TOPS of the load that the relevant RAID group is currently receiving and showing the value in percentage. The storage system 100 can perform update of the RG load (IOPS) periodically, such as every minute.

Although not shown, the RG marginal performance (IOPS) 3091 can be shown via throughput (MB/sec) or can be shown per Read/Write types. The RG load (%) 3092 can also be shown per Read/Write types.

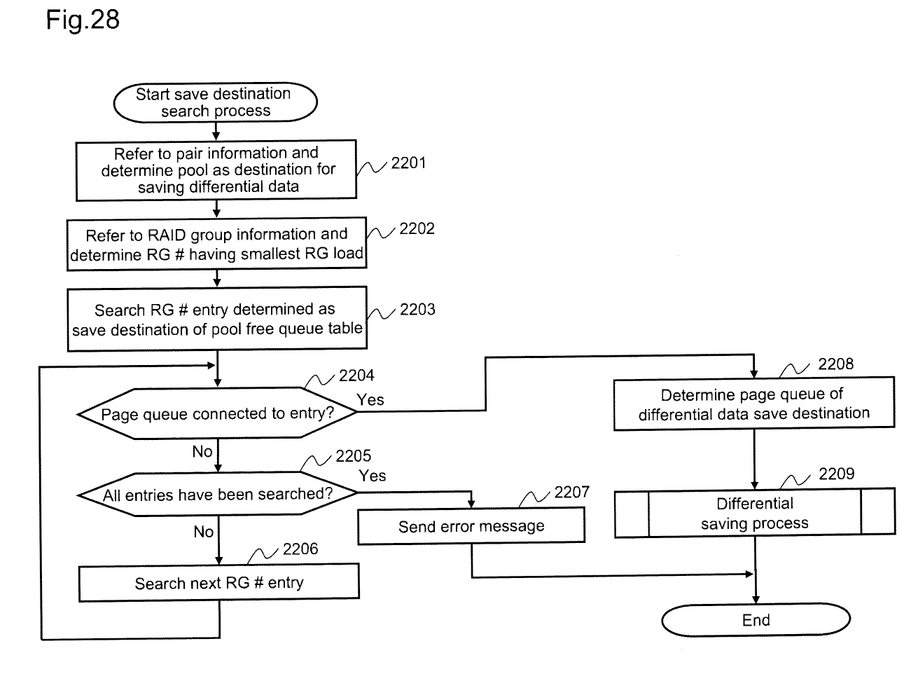

FIG. 28 is a flowchart showing the save destination search process according to embodiment 2. According to the save destination search process of embodiment 2, step 1102 of the save destination search process according to embodiment 1 is changed. According to step 1102 of embodiment 1, the previously used RG #3001 of the RG selection table 300 is referred to, and the RG # used for the current saving of differential data is determined.

On the other hand, embodiment 2 differs from embodiment 1 in that the status of load of the RAID groups is considered when determining the RG # to be used for saving differential data. In other words, the RAID group information 309 is referred to in step 2202 of FIG. 28, and the RG # used for saving the differential data is determined from the RG # having the smallest RG load (%) 3092. In other words, according to FIG. 27, the RG # having the smallest RG load (%) is RG #3081 “1” having a “30%” RG load 3092. The other steps shown in FIG. 28 are the same as the steps in the flowchart of FIG. 16.

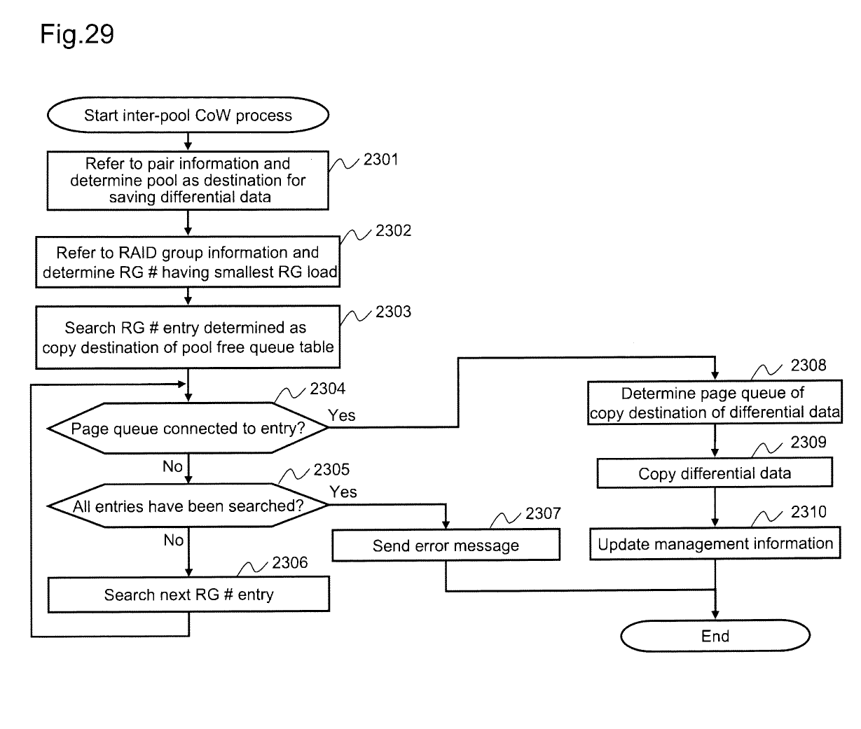

FIG. 29 is a flowchart showing the inter-pool CoW (Copy-on-Write) process according to embodiment 2. According to the inter-pool CoW process of embodiment 2, step 2102 of the inter-pool CoW process according to embodiment 1 shown in FIG. 26 is varied. The step (step 2302 in FIG. 29) is varied similarly as step 2202 of the aforementioned save destination search process of embodiment 2. Other steps shown in FIG. 29 are the same as the steps in the flowchart of FIG. 26.

As described, the load of RAID groups in the storage system 100 can be uniformized by selecting the RAID group for saving differential data and for performing the inter-pool CoW process of the differential data based on the status of load of the respective RAID groups and selecting the RAID group having the smallest load.

### Embodiment 3

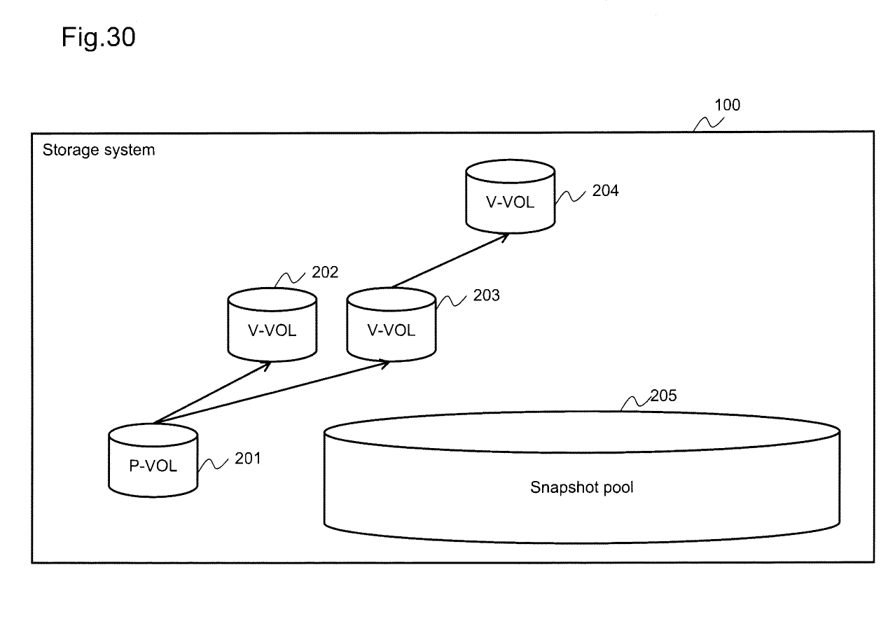

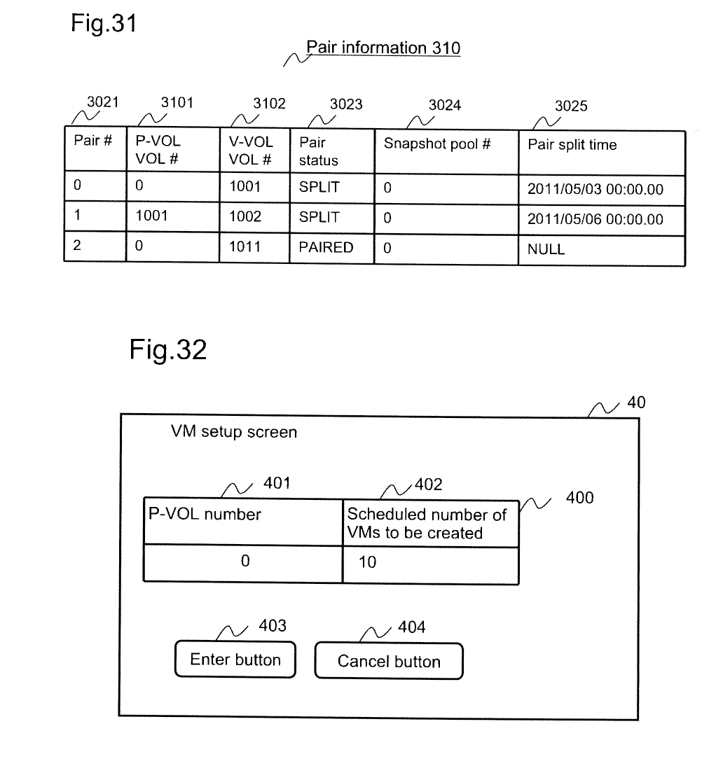

Now, the operation for further creating a snapshot virtual volume from a V-VOL according to the third embodiment of the present invention will be described with reference to FIGS. 30 and 31. FIG. 30 illustrates a snapshot structure of the storage system 100 according to embodiment 3. The storage system 100 includes a P-VOL 201, a V-VOL 202, a V-VOL 203, a V-VOL 204, and a snapshot pool 205. The difference of embodiment 3 from embodiment 1 is that a V-VOL 204 is created from V-VOL 203.

The purpose of the snapshot structure for creating a V-VOL 204 from the V-VOL 203 as shown in FIG. 30 will now be described. According to embodiment 1, the V-VOL 202 created from the P-VOL 201 is mapped to the VM 12 and used, but according to such configuration, it is impossible to acquire a backup of the V-VOL 202. Therefore, as shown in FIG. 30, according to the present embodiment, the V-VOL 204 created from the V-VOL 203 is used as backup of the V-VOL 204.

FIG. 31 shows pair information 310 according to embodiment 3. The pair information 310 is a table composed of a pair #3021 a P-VOL VOL #3101 (P-VOL VOLume number), a V-VOL VOL #3102 (V-VOL VOLume number), a pair status 3023, a snapshot pool #3024, and a pair split time 3025. The present pair information 310 differs from the pair information 302 shown in FIG. 7 in that the P-VOL LU #3026 is changed to P-VOL VOL #3101 and that the V-VOL #3022 is changed to V-VOL VOL #3102. Further, the respective process flows according to embodiment 3 are equivalent to embodiment 1.

According to embodiment 3, a pair composed of V-VOL and V-VOL (a pair of two V-VOLs) exist for creating a V-VOL 204 from V-VOL 203. Therefore, VOL identification numbers for uniquely identifying the P-VOLs and V-VOLs in the storage system 100 are assigned to all the P-VOLs and V-VOLs.

The VOL identification number of a P-VOL or a V-VOL which is the source of snapshot creation is entered to the P-VOL VOL #3011. The VOL identification number of the V-VOL created from the snapshot creation source is entered to the V-VOL VOL #3022. As described, the pair of P-VOL and V-VOL and the pair of V-VOL and V-VOL are managed.

As described, similar to embodiments 1 and 2, the present embodiment enables to reduce the load of the overall storage system and to enhance the speed of starting the VM by performing a normal write operation having a small load instead of the burdensome CoW (Copy-on-Write) operation that had been indispensible according to the prior art system when a host write request was issued during starting of the OS or the starting of the application program.

### INDUSTRIAL APPLICABILITY

The present invention can be applied to storage devices such as storage systems, information processing apparatus such as large-scale computers, servers and personal computers, and communication devices such as cellular phones and multifunctional portable terminals.

### REFERENCE SIGNS LIST

10 Host computer
11 Management computer
12 VM
100 Storage system
101 Controller
102 Host interface port
103 Processor
104 Main memory
105 Cache memory
106 Management port
107 Internal network
111 Logical volume
201 P-VOL
202, 203, 204 V-VOL
205 Snapshot pool
300 RG selection table
301 LU information
302 Pair information
303 P-VOL differential information
304 V-VOL differential information
305 Pool free space information
306 Page performance information
307, 310 Pool information
308, 309 RAID group information
312 Pool free queue table
313 Pool used queue table
40 VM setup screen
400 Starting VM number setup table
403 Enter button
404 Cancel button
3001 Previously used RG # (Previously used RG number)
3011 LU # (LU number)
3012 Capacity
3013 Port # (Port number)
3021 Pair # (Pair number)
3022 V-VOL # (V-VOL number)
3023 Pair status
3024 Snapshot pool # (Snapshot pool number)
3025 Pair split time
3026 P-VOL LU # (P-VOL LU number)
3031 P-VOL # (P-VOL number)
3032 Page # (Page number)
3033, 3041 Differential flag
3042 Shared V-VOL # (Shared V-VOL number)
3043 Reference destination address
3050 Page queue
3051 Queue number
3052 Belonging pool # (Belonging pool number)
3053 Belonging page # (Belonging page number)
3054 Post-save write flag
3055 Reference V-VOL number
3056 Next pointer
3057 Prey pointer
3061 Host write flag
3062 IOPS
3071, 3084 Total capacity
3072, 3085 Used capacity
3081 RG # (RG number)
3082 PDEV # (PDEV number)
3083 RAID type
3091 RG marginal performance
3092 RG load
3101 P-VOL VOL # (P-VOL VOL number)
3102 V-VOL VOL # (V-VOL VOL number)
3121 Pointer

1. A storage system coupled to a host computer, comprising:
a plurality of storage devices; and
a controller for providing storage areas of the plurality of storage devices as logical volumes to the host computer;
wherein a data shared among a plurality of virtual machines operating in the host computer is stored in one of said logical volumes;
wherein the controller specifies an area within said one logical volume receiving a write request during starting of the virtual machines;
creates one or more virtual volumes and sets a reference destination of the virtual volume to said one logical volume;
copies the data stored in the specified area to another area of the storage device and changes the reference destination of the virtual volume referring to said area to the copy destination;
maps the respective one or more virtual volumes to one of the plurality of virtual machines; and
starts the plurality of virtual machines, wherein a data write request to a shared data having been copied is written into the copy destination that the virtual volume mapped to the virtual machine refers to.

2. The storage system according to claim 1, wherein the controller further copies data stored in an area within said one logical volume receiving an amount of access exceeding a predetermined value during starting of the virtual machines to said another area and changes the reference destination of the virtual volume referring to said area receiving the amount of access exceeding a predetermined value to the copy destination.

3. The storage system according to claim 1, wherein the data stored in said one logical volume is an OS data.

4. The storage system according to claim 1, wherein the controller monitors an I/O access of each predetermined area constituting said logical volume when the virtual machine is started using the shared data stored in said one logical volume, and specifies an area within said one logical volume receiving the write request.

5. The storage system according to claim 1, wherein said another area of the storage device to which data is copied is a pool area composed of a plurality of RAID groups formed of said plurality of storage devices; and
copying of the data stored in the specified area to the pool area is performed so that data is distributed among the RAID groups.

6. The storage system according to claim 1, wherein
the controller receives a data write request to the virtual volume mapped to the virtual machine; and
overwrites the data of the write request to the copy destination if the reference destination of the area within the virtual volume having received the write request is the copy destination.

7. The storage system according to claim 6, wherein if the reference destination of the area within the virtual volume having received the write request is shared by another virtual volume, the controller further copies the data in the reference destination to another area, overwrites the data of the write request to the area of the copy destination, and changes the reference destination to the copy destination.

8. The storage system according to claim 6, wherein the controller receives the write request to the virtual volume mapped to the virtual machine, and
if the logical volume and the virtual volume are not in a paired status, sends an error message.

9. The storage system according to claim 5, wherein said another area of the storage device to which data is copied is a pool area composed of a plurality of RAID groups formed of said plurality of storage devices; and
copying of the data stored in the specified area to the pool area is performed so that load is distributed among the RAID groups.

10. The storage system according to claim 1, wherein the controller creates a number of virtual volumes designated by a user.

11. The storage system according to claim 1, wherein regarding an area within the another area being copied not having received any write request from the virtual machine, a reference destination of the virtual volume referring to said area is changed to an area of the logical volume being the copy source.

12. The storage system according to claim 1, wherein an another area within the another area being copied having no more virtual volumes referring thereto is freed.

13. The storage system according to claim 1, wherein the virtual volume mapped to the one virtual machine is further mapped to another virtual volume, and a reference destination of said another virtual volume is set to said virtual volume.

14. A data processing method performed in a storage system coupled to a host computer and comprising:
a plurality of storage devices; and
a controller for providing storage areas of the plurality of storage devices as logical volumes to the host computer;
wherein a data shared among a plurality of virtual machines operating in the host computer is stored in one of said logical volumes;
the data processing method comprising:
specifying an area within said one logical volume receiving a write request during starting of the virtual machines;
creating one or more virtual volumes and setting a reference destination of the virtual volume to said one logical volume;
copying the data stored in the specified area to another area of the storage device and changing the reference destination of the virtual volume referring to said area to the copy destination;
mapping the respective one or more virtual volumes to one of the plurality of virtual machines; and
starting the plurality of virtual machines, wherein a data write request to a shared data having been copied is written into the copy destination that the virtual volume mapped to the virtual machine refers to.

15. The data processing method according to claim 14, comprising further copying data stored in an area within said one logical volume receiving an amount of access exceeding a predetermined value during starting of the virtual machines to said another area and changing the reference destination of the virtual volume referring to said area receiving an amount of access exceeding a predetermined value to the copy destination.
